(19) United States
(12) Patent Application Publication
(10) Pub. No.: US 2017/0286049 A1
(43) Pub. Date: Oct. 5, 2017

(54) APPARATUS AND METHOD FOR RECOGNIZING VOICE COMMANDS

(71) Applicant: Samsung Electronics Co., Ltd., Gyeonggi-do (KR)

(72) Inventors: Kyung-Tae KIM, Gyeonggi-do (KR); Hyun-Soo KIM, Gyeonggi-do (KR); Ga-Jin SONG, Gyeonggi-do (KR)

(21) Appl. No.: 15/507,074

(22) PCT Filed: Aug. 27, 2014
(86) PCT No.: PCT/KR2014/007984

§ 371 Date: Feb. 27, 2017

(51) Int. Cl. G06F 3/16; G10L 13/08

(52) U.S. Cl. CPC G06F 3/162; G10L 13/086; G10L 13/08

(57) ABSTRACT

The variety of embodiments according to the present invention relate to an apparatus and a method for recognizing voice commands in an electronic apparatus. As such, the method for voice recognition comprises the operations of: outputting a voice or an audio signal comprising a plurality of successive components; receiving the voice signal; determining one or more components from among the plurality of components by utilizing the time at which the voice signal was received; and generating response information for the voice signal on the basis of one or more components or at least a part of the information regarding the component.

### BACKGROUND ART

Various embodiments of the present disclosure relates to voice command recognition, and more particularly, to an apparatus and a method for recognizing a voice command in view of a time point of utterance by a user.

With the progress of semiconductor technology and communication technology, electronic devices have developed into multimedia devices providing multimedia services using voice telephone calls and data communication. For example, an electronic device can provide various multimedia services, such as a data search, a voice recognition service, and the like.

Further, the electronic device can provide a voice recognition service according to the input of a natural language that a user can intuitively use without separate learning.

### DETAILED DESCRIPTION OF THE INVENTION

### Technical Problem

Therefore, various embodiments of the present disclosure are to provide an apparatus and a method for recognizing a voice command in view of a time point of utterance by a user in an electronic device.

Various embodiments of the present disclosure are to provide an apparatus and a method for recognizing a voice command in view of content information according to a time point of reception of a voice signal in an electronic device.

Various embodiments of the present disclosure are to provide an apparatus and a method for transmitting content information according to a time point of reception of a voice signal to a server for recognizing a voice command in an electronic device.

Various embodiments of the present disclosure are to provide an apparatus and a method for recognizing a voice command in view of content information and a voice signal received from an electronic device in a server.

In accordance with various embodiments of the present disclosure, an operating method of an electronic system is provided. The operating method may include providing a voice signal or an audio signal including multiple components; receiving a voice signal; determining one or more components among the multiple components by using a time point of receiving the voice signal; and generating response information to the voice signal based on the one or more components or at least part of information on the one or more components.

In an embodiment of the present disclosure, the voice signal or the audio signal may include the multiple continuous components.

In an embodiment of the present disclosure, information on the components may include one or more pieces of information among session information of the components and music file information.

In an embodiment of the present disclosure, a time point of the reception of the voice signal may include one or more of a time point of utterance by a user, an input time point of a command included in the voice signal, a time point of reception of an audio signal including the voice signal, and a time point of the reception of the voice signal.

In an embodiment of the present disclosure, the generating of the response information

may include generating content corresponding to the voice signal based on the one or more components or at least part of information on the one or more components.

In accordance with various embodiments of the present disclosure, an operating method of an electronic device is provided. The operating method may include outputting a voice signal or an audio signal including multiple continuous components; receiving a voice signal; determining one or more components among the multiple components by using a time point of receiving the voice signal; and generating response information to the voice signal based on the one or more components or at least part of information on the one or more components.

In an embodiment of the present disclosure, the receiving of the voice signal may include receiving an audio signal through a microphone; and extracting a voice signal included in the audio signal.

In an embodiment of the present disclosure, the generating of the response information may include converting the voice signal into text data; generating natural language information by using the one or more components or at least part of information on the one or more components and the text data; and determining content according to the voice signal based on the natural language information.

In accordance with various embodiments of the present disclosure, an operating method of an electronic device is provided. The operating method may include outputting a voice signal or an audio signal including multiple continuous components; receiving a voice signal; determining one or more components among the multiple components by using a time point of receiving the voice signal; and transmitting, to a server, the one or more components or at least part of information on the one or more components and the voice signal.

In accordance with various embodiments of the present disclosure, an operating method of a server is provided. The operating method may include receiving a voice signal from an electronic device; identifying one or more components according to the voice signal among multiple components included in a voice signal or an audio signal which is output from the electronic device; generating response information to the voice signal based on the one or more components or at least part of information on the one or more components; and transmitting, to the electronic device, the response information to the voice signal.

In accordance with various embodiments of the present disclosure, an operating method of an electronic device is provided. The operating method may include outputting a voice signal or an audio signal including multiple continuous components; transmitting information on the output voice signal or audio signal to a server; receiving a voice signal; and transmitting the voice signal to the server.

In an embodiment of the present disclosure, the outputting of the voice signal or the audio signal may include converting content into the voice signal or the audio signal by using a Text-To-Speech (TTS) module; and outputting the voice signal or the audio signal through a speaker.

In an embodiment of the present disclosure, the receiving of the voice signal may include receiving an audio signal through a microphone; and extracting a voice signal included in the audio signal.

In an embodiment of the present disclosure, the operating method may further include receiving response information to the voice signal from the server; and outputting the response information.

In an embodiment of the present disclosure, the operating method may further include receiving response information to the voice signal from the server; extracting content according to the response information from a memory and at least one content server; and outputting the content.

In accordance with various embodiments of the present disclosure, an operating method of a server is provided. The operating method may include receiving information on a voice signal or an audio signal including multiple components being output from an electronic device; receiving a voice signal from the electronic device; determining a time point of receiving the voice signal by the electronic device, by using the voice signal; determining one or more components output from the electronic device at the time point of receiving the voice signal, by using the information on the voice signal or the audio signal and the time point of receiving the voice signal by the electronic device; generating response information to the voice signal based on the one or more components or at least part of information on the one or more components; and transmitting, to the electronic device, the response information to the voice signal.

In an embodiment of the present disclosure, the generating of the response information may include generating natural language information by using the one or more components or at least part of information on the one or more components and the voice signal; and determining content according to the voice signal based on the natural language information.

In an embodiment of the present disclosure, the generating of the response information may include generating natural language information by using the one or more components or at least part of information on the one or more components and the voice signal; and generating a control signal for selecting content according to the voice signal based on the natural language information.

In accordance with various embodiments of the present disclosure, an electronic device is provided. The electronic device may include an output module that outputs a voice signal or an audio signal including multiple continuous components; a reception module that receives a voice signal; a controller that determines one or more components among the multiple components by using a time point of receiving the voice signal; and an operation determination module that generates response information to the voice signal based on the one or more components or at least part of information on the one or more components.

In an embodiment of the present disclosure, the electronic device may further include a microphone and the reception module may extract a voice signal from an audio signal received through the microphone.

In an embodiment of the present disclosure, the electronic device may further include a language recognition module that converts a voice signal received by the reception module into text data; and a natural language processing module that generates natural language information by using the one or more components or at least part of information on the one or more components and the text data, and the operation determination module may determine content according to the voice signal based on the natural language information.

In accordance with various embodiments of the present disclosure, an electronic device is provided. The electronic device may include an output module that outputs a voice signal or an audio signal including multiple continuous components; a reception module that receives a voice signal; and a controller that determines one or more components among the multiple components by using a time point of receiving the voice signal, wherein the electronic device may transmit, to a server, the one or more components or at least part of information on the one or more components and the voice signal.

In accordance with various embodiments of the present disclosure, a server is provided. The server may include a language recognition module that receives a voice signal from an electronic device; a natural language processing module that identifies one or more components according to the voice signal among multiple components included in a voice signal or an audio signal which is output from the electronic device; and an operation determination module that generates response information to the voice signal based on the one or more components or at least part of information on the one or more components, and transmits, to the electronic device, the response information to the voice signal.

In accordance with various embodiments of the present disclosure, an electronic device is provided. The electronic device may include an output module that outputs a voice signal or an audio signal including multiple continuous components; a controller that generates information on a voice signal or an audio signal which is output through the output module; a reception module that receives a voice signal; and wherein the electronic device may transmit, to a server, the information on the voice signal or the audio signal and the voice signal.

In accordance with various embodiments of the present disclosure, a server is provided. The server may include a language recognition module that receives a voice signal from an electronic device and determines a time point of reception of the voice signal by the electronic device by using the voice signal; a content determination module that receives information on a voice signal or an audio signal including multiple components being output from the electronic device, and that determines one or more components output from the electronic device at a time point of reception of a voice signal, by using the information on the voice signal or the audio signal and the time point of the reception of the voice signal which has been determined by the language recognition module; and an operation determination module that generates response information to the voice signal based on the one or more components or at least part of information on the one or more components and transmits the generated response information to the electronic device.

In an embodiment of the present disclosure, the server may further include the natural language processing module that generates natural language information by using the one or more components or at least part of information on the one or more components, which have been determined by the content determination module, and the voice signal.

In an embodiment of the present disclosure, the operation determination module may generate content according to the voice signal based on the natural language information generated by the natural language processing module.

In an embodiment of the present disclosure, the operation determination module may generate a control signal for selecting content according to the voice signal based on the natural language information generated by the natural language processing module.

### BRIEF DESCRIPTION OF THE DRAWINGS

FIG. 1 illustrates a block configuration of an electronic device for recognizing a voice command according to various embodiments of the present invention.

FIG. 2 illustrates a procedure for recognizing a voice command by an electronic device according to various embodiments of the present invention.

FIG. 3 illustrates a block configuration of a voice recognition system for recognizing a voice command in view of content information of an electronic device according to various embodiments of the present invention.

FIG. 4 illustrates a block configuration of a voice recognition system for recognizing a voice command in view of content information of an electronic device according to various embodiments of the present invention.

FIG. 5 illustrates a block configuration of a voice recognition system for recognizing a voice command in view of content information of an electronic device according to various embodiments of the present invention.

FIG. 6 illustrates a procedure for transmitting content information to a server by an electronic device according to various embodiments of the present invention.

FIG. 7 illustrates a procedure for recognizing a voice command in view of content information of an electronic device by a server according to various embodiments of the present invention.

FIG. 8 illustrates a block configuration of a voice recognition system for recognizing a voice command in view of content information of an electronic device according to various embodiments of the present invention.

FIG. 9 illustrates a procedure for transmitting content information to a server by an electronic device according to various embodiments of the present invention.

FIG. 10 illustrates a procedure for recognizing a voice command in view of content information of an electronic device by a server according to various embodiments of the present invention.

FIG. 11 illustrates a block configuration of a voice recognition system for recognizing a voice command in view of content information of an electronic device according to various embodiments of the present invention.

FIG. 12 illustrates a block configuration of a voice recognition system for recognizing a voice command in view of content information of an electronic device according to various embodiments of the present invention.

FIG. 13 illustrates a procedure for transmitting content information to a server by an electronic device according to various embodiments of the present invention.

FIG. 14 illustrates a procedure for recognizing a voice command in view of content information of an electronic device by a server according to various embodiments of the present invention.

FIG. 15 illustrates a block configuration of a voice recognition system for recognizing a voice command in view of content information of an electronic device according to various embodiments of the present invention.

FIG. 16 illustrates a block configuration of a voice recognition system for recognizing a voice command in view of content information of an electronic device according to various embodiments of the present invention.

FIG. 17 illustrates a procedure for transmitting content information to a server by an electronic device according to various embodiments of the present invention.

FIG. 18 illustrates a procedure for recognizing a voice command in view of content information of an electronic device by a server according to various embodiments of the present invention.

FIG. 19 illustrates a block configuration of a voice recognition system for recognizing a voice command in view of content information of an electronic device according to various embodiments of the present invention.

FIG. 20 illustrates a screen configuration for recognizing a voice command according to various embodiments of the present invention.

FIG. 21 illustrates a screen configuration for recognizing a voice command according to various embodiments of the present invention.

### MODE FOR CARRYING OUT THE INVENTION

Hereinafter, various embodiments of the present disclosure will be described in detail with reference to the accompanying drawings. Further, in the following description of the present disclosure, a detailed description of known functions and configurations incorporated herein will be omitted when it may make the subject matter of the present disclosure rather unclear. The terms which will be described below are terms defined in consideration of the functions in embodiments of the present disclosure, and may vary depending on users, intentions of operators, or customs. Therefore, the definitions of the terms should be made based on the contents throughout the specification.

Hereinafter, in various embodiments of the present disclosure, a description will be made of technology which allows an electronic device to recognize a voice command in view of content information on a time point of reception of a voice signal.

In the following description, the electronic devices may be devices, such as portable electronic devices, portable terminals, mobile terminals, mobile pads, media players, Personal Digital Assistants (PDAs), desktop computers, laptop computers, smart phones, netbooks, televisions, Mobile Internet Devices (MIDs), Ultra Mobile Personal Computers (UMPCs), tablet PCs, navigations, Moving Picture Experts Group (MPEG) Audio Layer 3 (MP3), or the like. Also, the electronic device may be an optional electronic device implemented by combining functions of two or more devices from among the above-described devices.

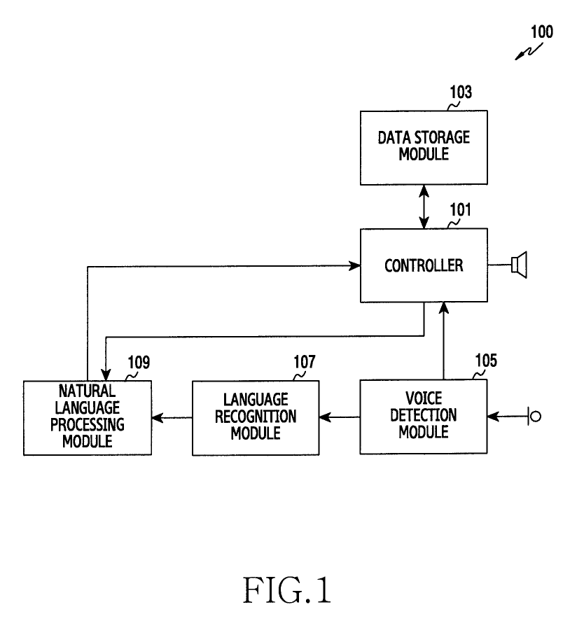

FIG. 1 illustrates a block configuration of an electronic device for recognizing a voice command according to various embodiments of the present disclosure.

Referring to FIG. 1, the electronic device 100 may include a controller 101, a data storage module 103, a voice detection module 105, a language recognition module 107, and a natural language processing module 109.

The controller 101 may control an overall operation of the electronic device 100. At this time, the controller 101 may control a speaker to output content according to a control command received from the natural language processing module 109. Here, the content may include a voice or an audio signal including a sequence of multiple components. For example, the controller 101 may include a Text-To-Speech (TTS) module. When a control command related to “weather” reproduction is received from the natural language processing module 109, the controller 101 may extract weather data from the data storage module 103 or an external server. The TTS module may convert the weather data extracted by the controller 101 into a voice signal or an audio signal sequentially including multiple components, such as “on Jul. 1, 2013, currently, the weather in the Seoul area is hot and humid with a temperature of 34 degrees Celsius and a humidity of 60%,” and “it will be mostly hot and humid this week, and the seasonal rain front will bring heavy rain later this week,” and may output the voice signal or the audio signal through the speaker.

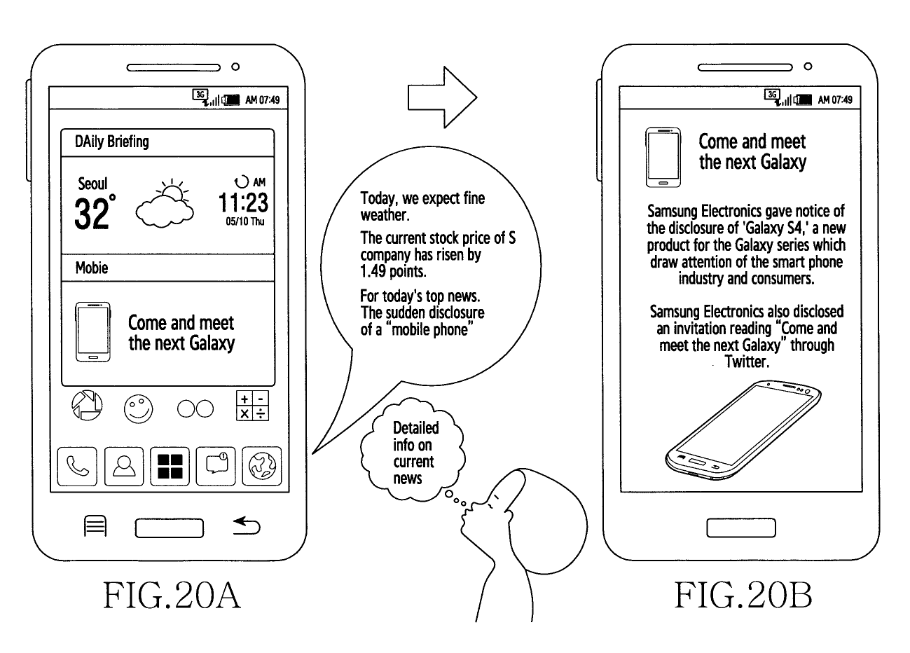

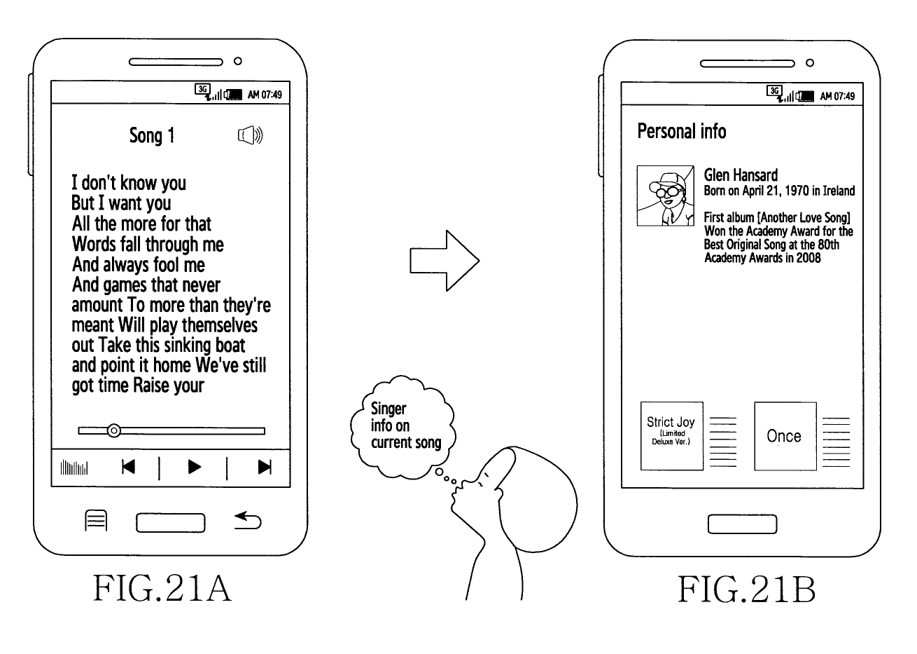

The controller 101 may transmit content information on content, which is being output through the speaker at a time point when the voice detection module 105 extracts the voice signal, to the natural language processing module 109. At this time, the controller 101 may identify time point information on a time point when the voice detection module 105 has extracted a voice signal, from voice signal extraction information received from the voice detection module 105. For example, when a daily briefing service is provided with reference to FIG. 20A, the controller 101 may extract a sequence of multiple components, such as weather information 2001, stock information 2003, and major news 2005, and may output the extracted sequence of the multiple components through the speaker, according to setting information of the daily briefing service. When the voice detection module 105 extracts a voice signal during reproduction of the major news 2005, the controller 101 may transmit content information on the major news 2005 to the natural language processing module 109. As another example, when a music reproduction service is provided with reference to FIG. 21A, the controller 101 may reproduce one or more music files included in a reproduction list and may output the one or more reproduced music files through the speaker. When the voice detection module 105 extracts a voice signal during reproduction of “song 1,” the controller 101 may transmit content information on “song 1” to the natural language processing module 109. As still another example, the controller 101 may transmit, to the natural language processing module 109, content information on content reproduced at a time point preceding, by a reference time period, a time point when the voice detection module 105 extracts a voice signal. However, when the content does not exist which is being output through the speaker at the time point when the voice detection module 105 extracts the voice signal, the controller 101 may not transmit the content information to the natural language processing module 109.

The data storage module 103 may store at least one program for controlling an operation of the electronic device 100, data for executing a program, and data generated during execution of a program. For example, the data storage module 103 may store various pieces of content information on a voice command.

The voice detection module 105 may extract a voice signal from an audio signal collected through a microphone and may provide the extracted voice signal to the language recognition module 107. For example, the voice detection module 105 may include an Adaptive Echo Canceller (AEC) capable of canceling an echo component from an audio signal collected through the microphone, and a Noise Suppressor (NS) capable of suppressing background noise from an audio signal received from the AEC. Accordingly, the voice detection module 105 may extract a voice signal from the audio signal, from which the echo component and the background noise are removed by the AEC and the NS. Here, the term “echo” may refer to a phenomenon in which an audio signal, which is output through the speaker, flows into the microphone.

When the voice detection module 105 extracts the voice signal from the audio signal collected through the microphone as described above, the voice detection module 105 may provide voice signal extraction information to the controller 101 at a time point of extraction of the voice signal. Here, the voice signal extraction information may include time point information on the time point when the voice detection module 105 has extracted the voice signal.

The language recognition module 107 may convert the voice signal, which has been received from the voice detection module 105, into text data.

The natural language processing module 109 may analyze the text data received from the language recognition module 107, and may extract the intent of a user and a keyword which are included in the text data. For example, the natural language processing module 109 may analyze the text data received from the language recognition module 107, and may extract a voice command included in the voice signal.

The natural language processing module 109 may include an operation determination module. The operation determination module may generate a control command for an operation of the controller 101 according to the voice command extracted by the natural language processing module 109.

The natural language processing module 109 may analyze the text data received from the language recognition module 107 by using the content information received from the controller 101, and thereby may extract a voice command included in the voice signal. For example, when the text data “detailed information on current news” is received from the language recognition module 107, the natural language processing module 109 may analyze the text data received from the language recognition module 107, and may recognize that the voice signal requires detailed information on news currently being reproduced. At this time, the natural language processing module 109 may recognize accurate information on the news currently being reproduced, in view of the content information received from the controller 101.

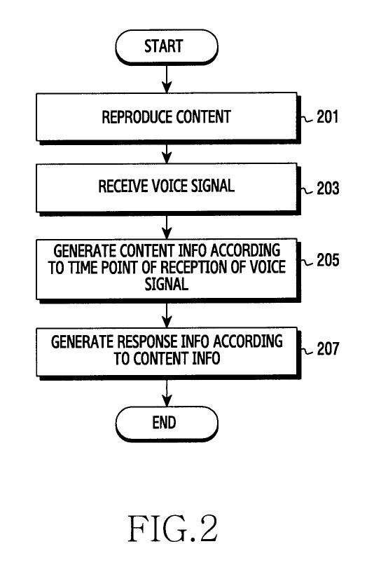

FIG. 2 illustrates a procedure for recognizing a voice command by an electronic device according to various embodiments of the present disclosure.

Referring to FIG. 2, in operation 201, the electronic device may provide content. For example, the electronic device may extract content according to a control command extracted by the natural language processing module 109, from the data storage module 103 or an external server, and may reproduce the extracted content. At this time, the electronic device may convert the content, which is extracted from the data storage module 103 or the external server, into a voice signal or an audio signal by using a TTS module, and may output the voice signal or the audio signal through the speaker. Here, the voice signal or the audio signal may include a sequence of multiple components.

While the content is provided, in operation 203, the electronic device may receive a voice signal. For example, the electronic device may extract a voice signal from an audio signal received through the microphone.

When the voice signal is received, in operation 205, the electronic device may generate information on the content being reproduced at a time point of reception of the voice signal. The electronic device may select one or more components according to a time point of reception of the voice signal during the reproduction of the voice signal or the audio signal including a sequence of the multiple components being reproduced. For example, when a voice signal is received during reproduction of the major news 2005 according to a daily briefing service with reference to FIG. 20A, the electronic device may generate content information on the major news 2005. As another example, when a voice signal is received during reproduction of a music file included in a reproduction list with reference to FIG. 21A, the electronic device may generate content information on “song 1” being reproduced. As still another example, the electronic device may generate content information on content reproduced at a time point preceding, by a reference time period, a time point of reception of a voice signal. However, when the content does not exist which is being output through the speaker at the time point of reception of the voice signal, the electronic device may not generate content information. Here, the content information may include information on one or more components, which are being reproduced at the time point of reception of the voice signal, among the multiple components included in the content being reproduced. The information on a component may include one or more pieces of information among component session information and music file information.

In operation 207, the electronic device may generate response information on the voice signal, which has been received in operation 203, on the basis of the information on the content being reproduced at the time point of reception of the voice signal. For example, the electronic device may generate a control command according to the information on the content being reproduced at the time point of reception of the voice signal and the voice signal received in operation 203. For example, when a voice signal is converted into the text data “detailed information on current news,” the natural language processing module 109 of the electronic device may analyze the text data, and may recognize that the voice signal requires detailed information on news currently being reproduced. At this time, according to the content information on the content being reproduced at the time point of reception of the voice signal, the natural language processing module 109 may recognize that the voice signal requires detailed information on “sudden disclosure of a mobile phone.” The electronic device may generate a control command for reproducing the detailed information on “sudden disclosure of a mobile phone.” The electronic device may generate content related to the voice signal in view of the control command according to the information on the content being reproduced at the time point of reception of the voice signal and the voice signal received in operation 203. For example, when a voice signal related to “detailed information on current news” is received during provision of a daily briefing service with reference to FIG. 20A, the electronic device may reproduce detailed news information on “sudden disclosure of a mobile phone” as illustrated in FIG. 20B. At this time, the electronic device may convert detailed news on “sudden disclosure of a mobile phone” into a voice signal through the TTS module, and may output the voice signal through the speaker. As another example, when a voice signal related to “singer information on the current song” is received during reproduction of music with reference to FIG. 21A, the electronic device may reproduce singer information on “song 1” as illustrated in FIG. 21B. At this time, the electronic device may convert singer information on “song 1” into a voice signal through the TTS module, and may output the voice signal through the speaker.

In the above-described embodiment, the electronic device may include the controller 101, the data storage module 103, the voice detection module 105, the language recognition module 107, and the natural language processing module 109, and may extract a voice command related to a voice signal.

In another embodiment, the electronic device may be configured to extract a voice command related to a voice signal by using a server.

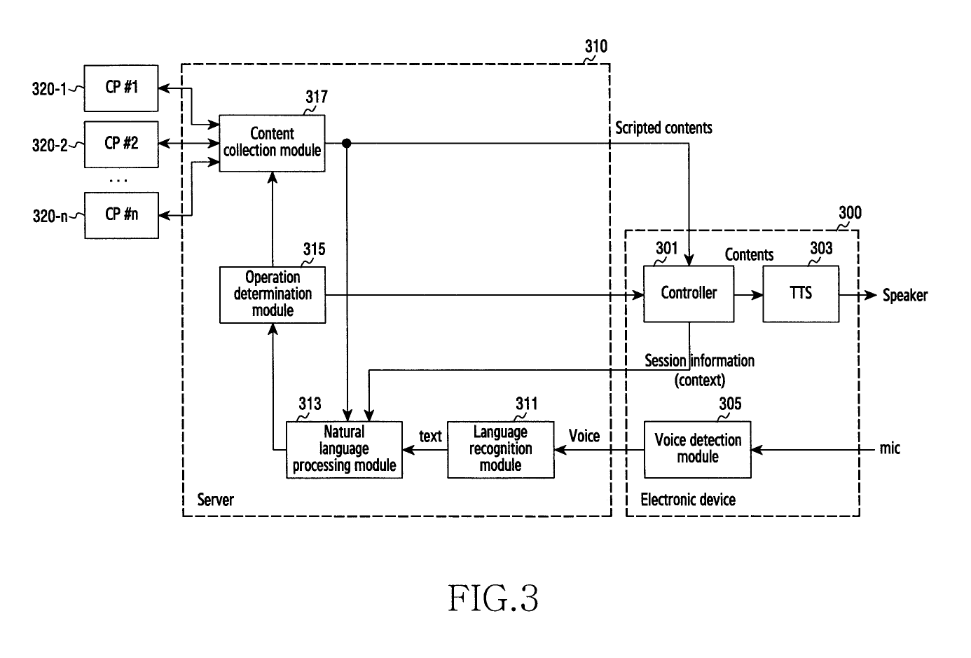

FIG. 3 illustrates a block configuration of a voice recognition system for recognizing a voice command in view of content information of an electronic device according to various embodiments of the present disclosure.

Referring to FIG. 3, the voice recognition system may include the electronic device 300 and a server 310.

The electronic device 300 may receive a voice signal through a microphone, and may reproduce content received from the server 310. For example, the electronic device 300 may include a controller 301, a TTS module 303, and a voice detection module 305.

The controller 301 may control an overall operation of the electronic device 300. The controller 301 may perform a control operation for reproducing content received from the server 310. For example, the controller 301 may perform a control operation for converting the content, which has been received from the server 310, into a voice signal or an audio signal through the TTS module 303, and outputting the voice signal or the audio signal through a speaker. Here, the voice signal or the audio signal may include a sequence of multiple components.

The controller 301 may transmit content information on content, which is being output through the speaker at a time point when the voice detection module 305 extracts the voice signal, to the server 310. For example, when a daily briefing service is provided with reference to FIG. 20A, the controller 301 may perform a control operation for extracting a sequence of multiple components, such as weather information 2001, stock information 2003, and major news 2005, and outputting the extracted sequence of the multiple components through the speaker, according to setting information of the daily briefing service. When the voice detection module 305 extracts a voice signal during the reproduction of the major news 2005, the controller 301 may transmit content information on the major news 2005 to the server 310. As another example, when a music reproduction service is provided with reference to FIG. 21A, the controller 301 may perform a control operation for reproducing one or more music files included in a reproduction list and outputting the one or more reproduced music files through the speaker. When the voice detection module 305 extracts a voice signal during reproduction of “song 1,” the controller 301 may transmit content information on “song 1” to the server 310. As still another example, the controller 301 may transmit, to the server 310, content information on content reproduced at a time point preceding, by a reference time period, a time point of reception of voice signal extraction information. However, when the content does not exist which is being output through the speaker at the time point when the voice detection module 305 extracts the voice signal, the controller 301 may not transmit the content information to the server 310.

The TTS module 303 may convert the content, which has been received from the controller 301, into a voice signal or an audio signal, and may output the voice signal or the audio signal through the speaker.

The voice detection module 305 may extract a voice signal from an audio signal collected through the microphone and may provide the extracted voice signal to the server 310. For example, the voice detection module 305 may include an AEC capable of canceling an echo component from an audio signal collected through the microphone, and an NS capable of suppressing background noise from an audio signal received from the AEC. Accordingly, the voice detection module 305 may extract a voice signal from the audio signal, from which the echo component and the background noise are removed by the AEC and the NS. Here, the term “echo” may refer to a phenomenon in which an audio signal, which is output through the speaker, flows into the microphone.

When the electronic device 300 transmits the content information and the voice signal to the server 310 as described above, the electronic device 300 may independently transmit the content information and the voice signal to the server 310, or may add the content information to the voice signal and may transmit, to the server 310, the content information added to the voice signal.

The server 310 may extract a voice command by using the content information and the voice signal received from the electronic device 300, and may extract content according to the voice command from content providing servers 320-1 to 320-n and may transmit the extracted content to the electronic device 300. For example, the server 310 may include a language recognition module 311, a natural language processing module 313, an operation determination module 315, and a content collection module 317.

The language recognition module 311 may convert the voice signal, which has been received from the voice detection module 305 of the electronic device 300, into text data.

The natural language processing module 313 may analyze the text data received from the language recognition module 311, and may extract the intent of a user and a keyword which are included in the text data. The natural language processing module 313 may analyze the text data received from the language recognition module 311, and may extract a voice command included in the voice signal. At this time, the natural language processing module 313 may analyze the text data received from the language recognition module 311 by using the content information received from the controller 301 of the electronic device 300, and thereby may extract a voice command included in the voice signal. For example, when the text data “detailed information on current news” is received from the language recognition module 311, the natural language processing module 313 may analyze the text data received from the language recognition module 311, and may recognize that the voice signal requires detailed information on news currently being reproduced. At this time, the natural language processing module 313 may recognize accurate information on the news currently being reproduced, in view of the content information received from the controller 301.

The operation determination module 315 may generate a control command for an operation of the controller 301 according to the voice command extracted by the natural language processing module 313. For example, when the natural language processing module 313 recognizes that detailed information on “news currently being reproduced (e.g., the sudden disclosure of a mobile phone)” is required, the operation determination module 315 may generate a control command for reproducing the detailed information on “sudden disclosure of a mobile phone.”

The content collection module 317 may collect content, which is to be provided from the content providing servers 320-1 to 320-n to the electronic device 300, according to the control command received from the operation determination module 315, and may transmit the collected content to the electronic device 300. For example, when the control command for reproducing the detailed information on “sudden disclosure of a mobile phone” is received from the operation determination module 315, the content collection module 317 may collect one or more pieces of content related to “sudden disclosure of a mobile phone” from the content providing servers 320-1 to 320-n, and may transmit the collected one or more pieces of content to the electronic device 300.

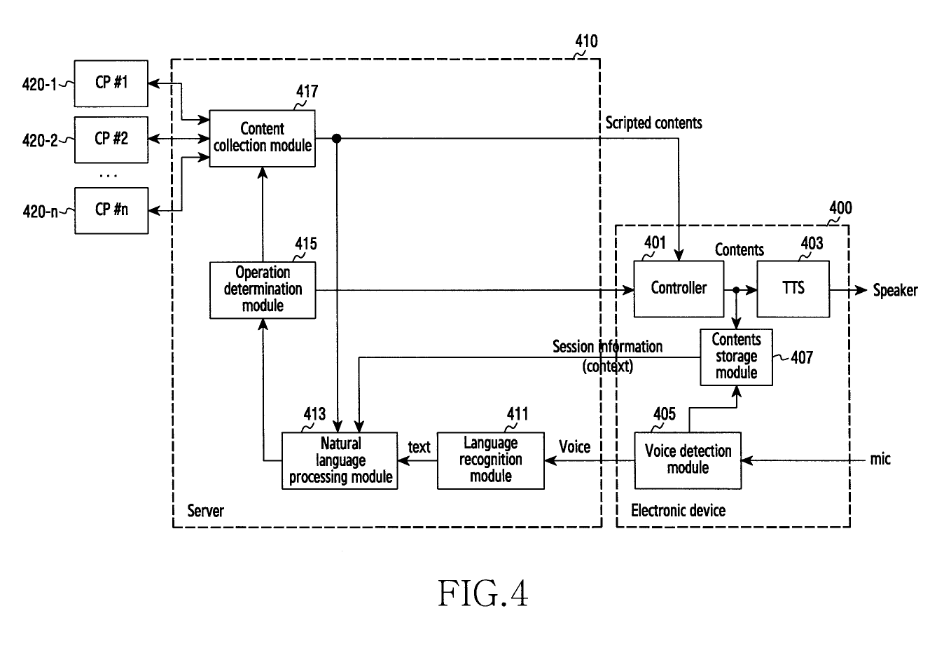

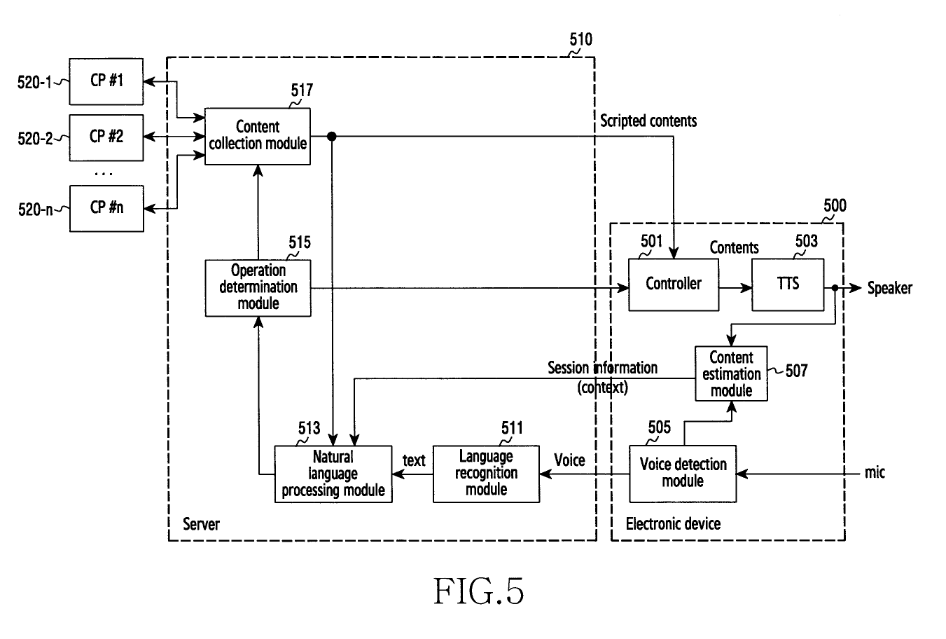

As described above, the controller 301 of the electronic device 300 may transmit, to the server 310, content information on content which is being output through the speaker at a time point when the voice detection module 305 detects a voice signal. At this time, the electronic device 300 may identify the content, which is being reproduced at a time point when the voice detection module 305 detects a voice signal, by using a content estimation module 407 or 507 with reference to FIG. 4 or 5 below.

FIG. 4 illustrates a block configuration of a voice recognition system for recognizing a voice command in view of content information of an electronic device according to various embodiments of the present disclosure.

Referring to FIG. 4, the voice recognition system may include the electronic device 400 and a server 410. In the following description, a configuration and an operation of the server 410 are identical to those of the server 310 illustrated in FIG. 3, and thus, a detailed description thereof will be omitted.

The electronic device 400 may receive a voice signal through a microphone, and may reproduce content received from the server 410. For example, the electronic device 400 may include a controller 401, a TTS module 403, a voice detection module 405, and the content estimation module 407.

The controller 401 may control an overall operation of the electronic device 400. The controller 401 may perform a control operation for reproducing content received from the server 410. For example, the controller 401 may perform a control operation for converting the content, which has been received from the server 410, into a voice signal or an audio signal through the TTS module 403, and outputting the voice signal or the audio signal through a speaker.

The TTS module 403 may convert the content, which has been received from the controller 401, into a voice signal or an audio signal, and may output the voice signal or the audio signal through the speaker. Here, the voice signal or the audio signal may include a sequence of multiple components.

The voice detection module 405 may extract a voice signal from an audio signal collected through the microphone and may provide the extracted voice signal to the server 410. For example, the voice detection module 405 may include an AEC capable of canceling an echo component from an audio signal collected through the microphone, and an NS capable of suppressing background noise from an audio signal received from the AEC. Accordingly, the voice detection module 405 may extract a voice signal from the audio signal, from which the echo component and the background noise are removed by the AEC and the NS. Here, the term “echo” may refer to a phenomenon in which an audio signal, which is output through the speaker, flows into the microphone.

When the voice signal is extracted from the audio signal collected through the microphone, the voice detection module 405 may generate voice signal extraction information at a time point of extraction of the voice signal and may transmit the generated voice signal extraction information to the content estimation module 407. Here, the voice signal extraction information may include time point information on the time point when the voice detection module 405 has extracted the voice signal.

The content estimation module 407 may monitor content transmitted from the controller 401 to the TTS module 403. Accordingly, the content estimation module 407 may identify information on the content transmitted from the controller 401 to the TTS module 403 at a time point of extraction of the received voice signal by the voice detection module 405, and may transmit the identified information to the server 410. At this time, the content estimation module 407 may identify the time point when the voice detection module 405 has extracted the received voice signal, from the voice signal extraction information received from the voice detection module 405. For example, when a daily briefing service is provided with reference to FIG. 20A, the controller 401 may transmit, to the TTS module 403, a sequence of multiple components, such as weather information 2001, stock information 2003, and major news 2005, according to setting information of the daily briefing service. When the voice detection module 405 extracts a voice signal during the transmission of the major news 2005 to the TTS module 403, the content estimation module 407 may transmit content information on the major news 2005 to the server 410. At this time, the content estimation module 407 may transmit, to the server 410, information on content transmitted from the controller 401 to the TTS module 403 at a time point preceding, by a reference time period, the time point when the voice detection module 405 extracts the voice signal. However, when the content does not exist which is transmitted from the controller 401 to the TTS module 403 at the time point when the voice detection module 405 extracts the voice signal, the content estimation module 407 may not transmit the content information to the server 410.

FIG. 5 illustrates a block configuration of a voice recognition system for recognizing a voice command in view of content information of an electronic device according to various embodiments of the present disclosure.

Referring to FIG. 5, the voice recognition system may include the electronic device 500 and a server 510. In the following description, a configuration and an operation of the server 510 are identical to those of the server 310 illustrated in FIG. 3, and thus, a detailed description thereof will be omitted.

The electronic device 500 may receive a voice signal through a microphone, and may reproduce content received from the server 510. For example, the electronic device 500 may include a controller 501, a TTS module 503, a voice detection module 505, and the content estimation module 507.

The controller 501 may control an overall operation of the electronic device 500. The controller 501 may perform a control operation for reproducing content received from the server 510. For example, the controller 501 may perform a control operation for converting the content, which has been received from the server 510, into a voice signal or an audio signal through the TTS module 503, and outputting the voice signal or the audio signal through a speaker.

The TTS module 503 may convert the content, which has been received from the controller 501, into a voice signal or an audio signal, and may output the voice signal or the audio signal through the speaker. Here, the voice signal or the audio signal may include a sequence of multiple components.

The voice detection module 505 may extract a voice signal from an audio signal collected through the microphone and may provide the extracted voice signal to the server 510. For example, the voice detection module 505 may include an AEC capable of canceling an echo component from an audio signal collected through the microphone, and an NS capable of suppressing background noise from an audio signal received from the AEC. Accordingly, the voice detection module 505 may extract a voice signal from the audio signal, from which the echo component and the background noise are removed by the AEC and the NS. Here, the term “echo” may refer to a phenomenon in which an audio signal, which is output through the speaker, flows into the microphone.

When the voice signal is extracted from the audio signal collected through the microphone, the voice detection module 505 may generate voice signal extraction information at a time point of extraction of the voice signal and may transmit the generated voice signal extraction information to the content estimation module 507. Here, the voice signal extraction information may include time point information on the time point when the voice detection module 505 has extracted the voice signal.

The content estimation module 507 may monitor content which is output from the TTS module 503. Accordingly, the content estimation module 507 may identify information on the content, which has been output from the TTS module 503 at a time point of extraction of the voice signal by the voice detection module 505, and may transmit the identified information to the server 510. At this time, the content estimation module 507 may identify the time point when the voice detection module 505 has extracted the voice signal, from the voice signal extraction information received from the voice detection module 505. For example, when a daily briefing service is provided with reference to FIG. 20A, the TTS module 503 may convert weather information 2001, stock information 2003, and major news 2005 into a voice signal and may output the voice signal through the speaker, according to setting information of the daily briefing service. When the voice detection module 505 extracts a voice signal while the TTS module 503 outputs the voice signal related to the major news 2005 through the speaker, the content estimation module 507 may transmit content information on the major news 2005 to the server 510. At this time, the content estimation module 507 may transmit, to the server 510, content information on content that the TTS module 503 has output through the speaker at a time point preceding, by a reference time period, the time point when the voice detection module 505 extracts the voice signal. However, when the content does not exist which is transmitted from the TTS module 503 at the time point when the voice detection module 505 extracts the voice signal, the content estimation module 507 may not transmit the content information to the server 510.

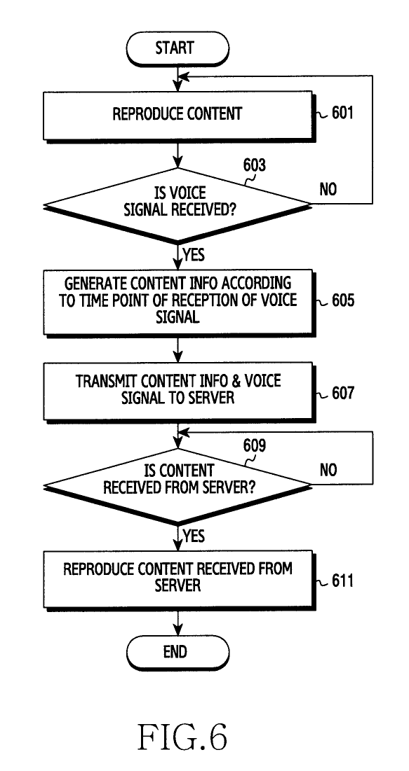

FIG. 6 illustrates a procedure for transmitting content information to a server by an electronic device according to various embodiments of the present disclosure.

Referring to FIG. 6, in operation 601, the electronic device may reproduce content. For example, the electronic device may convert the content, which has been received from the server, into a voice signal or an audio signal by using a TTS module, and may output the voice signal or the audio signal through a speaker. Here, the voice signal or the audio signal may include a sequence of multiple components.

While the content is reproduced, in operation 603, the electronic device may receive a voice signal. For example, the electronic device may extract a voice signal from an audio signal received through a microphone.

When the voice signal is received, in operation 605, the electronic device may generate content information on the content being reproduced at a time point of reception of the voice signal. The electronic device may select one or more components according to a time point of reception of the voice signal during the reproduction of the voice signal or the audio signal including a sequence of the multiple components being reproduced. For example, referring to FIG. 4, by using the content estimation module 407, the electronic device may identify the content transmitted from the controller 401 to the TTS module 403 at a time point of extraction of the received voice signal by the voice detection module 405, and may generate content information. At this time, the electronic device may identify content transmitted from the controller 401 to the TTS module 403 at a time point preceding, by a reference time period, the time point when the voice detection module 405 extracts the voice signal, and may generate content information. However, when the content does not exist which is transmitted from the controller 401 to the TTS module 403 at the time point of reception of the voice signal, the electronic device may not generate the content information. As another example, referring to FIG. 5, by using the content estimation module 507, the electronic device may identify the content, which has been output from the TTS module 503 at a time point of extraction of the received voice signal by the voice detection module 505, and may generate content information. At this time, the electronic device may identify content which has been output from the TTS module 503 at a time point preceding, by a reference time period, the time point when the voice detection module 505 extracts the received voice signal, and may generate content information. However, when the content does not exist which is output from the TTS module 503 at the time point of reception of the voice signal, the electronic device may not generate the content information. Here, the content information may include information on one or more components, which are being reproduced at the time point of reception of the voice signal, among the multiple components included in the content being reproduced. The information on a component may include one or more pieces of information among component session information and music file information.

Then, in operation 607, the electronic device may transmit the content information and the voice signal to the server. At this time, the electronic device may independently transmit the content information and the voice signal to the server, or may add the content information to the voice signal and may transmit, to the server, the content information added to the voice signal.

Then, in operation 609, the electronic device may determine whether content has been received from the server. In operation 607, the electronic device may determine whether a response to the voice signal transmitted to the server has been received.

When the content has been received from the server, in operation 611, the electronic device may reproduce the content received from the server. At this time, the electronic device may convert the content, which has been received from the server through the TTS module, into a voice signal, and may output the voice signal through the speaker.

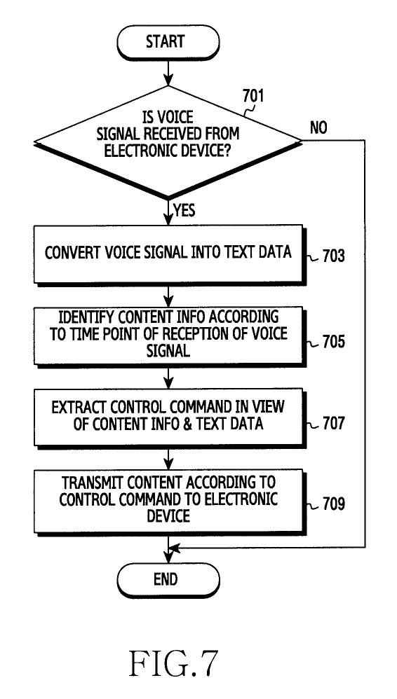

FIG. 7 illustrates a procedure for recognizing a voice command in view of content information of an electronic device by a server according to various embodiments of the present disclosure.

Referring to FIG. 7, in operation 701, the server may determine whether a voice signal has been received from the electronic device.

When the voice signal has been received from the electronic device, in operation 703, the server may convert the voice signal, which has been received from the electronic device, into text data.

In operation 705, the server may identify information on content that the electronic device has been reproducing at a time point of reception of the voice signal. For example, the server may receive content information from the electronic device. As another example, in operation 701, the server may identify content information included in the voice signal received from the electronic device.

In operation 707, the electronic device may generate a control command in view of the content information and voice signal. For example, when the voice signal is converted into the text data “detailed information on current news,” the server may analyze the text data through a natural language processing module, and may recognize that the voice signal requires detailed information on news currently being reproduced. At this time, according to the content information received from the electronic device, the natural language processing module may recognize that the voice signal requires detailed information on “sudden disclosure of a mobile phone.” Accordingly, the electronic device may generate a control command for reproducing the detailed information on “sudden disclosure of a mobile phone.”

In operation 709, the server may extract content according to the control command and may transmit the extracted content to the electronic device. For example, referring to FIG. 3, the server may extract content according to the control command from the content providing servers 320-1 to 320-n, and may transmit the extracted content to the electronic device 300.

In the above-described embodiment, the electronic device may transmit, to the server, the content information on the content which is being output through the speaker at the time point of reception of the voice signal.

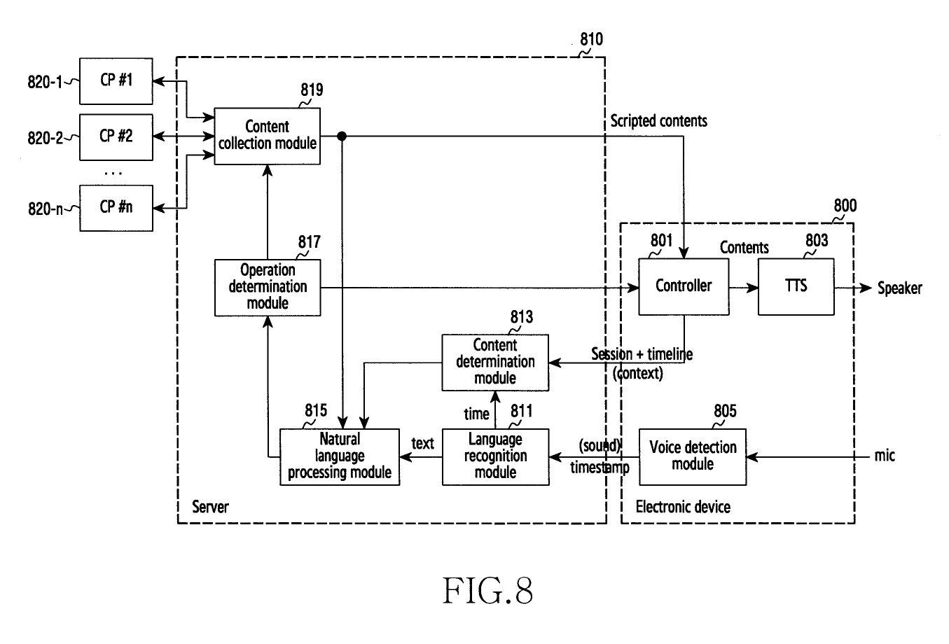

In another embodiment, the electronic device may transmit, to the server, content reproduced by the electronic device and reproduction time point information of the content, with reference to FIG. 8 below.

FIG. 8 illustrates a block configuration of a voice recognition system for recognizing a voice command in view of content information of an electronic device according to various embodiments of the present disclosure.

Referring to FIG. 8, the voice recognition system may include the electronic device 800 and a server 810.

The electronic device 800 may receive a voice signal through a microphone, and may output content, which has been received from the server 810, through a speaker. For example, the electronic device 800 may include a controller 801, a TTS module 803, and a voice detection module 805.

The controller 801 may control an overall operation of the electronic device 800. At this time, the controller 801 may perform a control operation for outputting the content, which has been received from the server 810, through the speaker. Here, the content may include a voice signal or an audio signal including a sequence of multiple components.

The controller 801 may transmit content reproduction information, which is output through the speaker, to the server 810. Here, the content reproduction information may include content, that the electronic device 800 reproduces according to the control of the controller 801, and reproduction time point information of the relevant content. For example, when a daily briefing service is provided with reference to FIG. 20A, the controller 801 may perform a control operation for extracting a sequence of multiple components, such as weather information 2001, stock information 2003, and major news 2005, and outputting the extracted sequence of the multiple components through the speaker, according to setting information of the daily briefing service. In this case, the controller 801 may transmit, to the server 810, information on the weather information 2001, the stock information 2003, and the major news 2005, which are output through the speaker, and reproduction time point information of each of the weather information 2001, the stock information 2003, and the major news 2005. As another example, when a music reproduction service is provided with reference to FIG. 21A, the controller 801 may perform a control operation for reproducing music files included in a reproduction list and outputting the one or more reproduced music files through the speaker. In this case, the controller 801 may transmit, to the server 810, music file information on the reproduced music files and reproduction time point information of each of the music files. At this time, whenever content is reproduced, the controller 801 may transmit, to the server 810, content information on the relevant content and reproduction time point information of the relevant content.

The TTS module 803 may convert the content, which has been received from the controller 801, into a voice signal or an audio signal, and may output the voice signal or the audio signal through the speaker.

The voice detection module 805 may extract a voice signal from an audio signal collected through the microphone and may provide the extracted voice signal to the server 810. At this time, the voice detection module 805 may transmit information on a time point of extraction of the voice signal and the voice signal together to the server 810. For example, the voice detection module 805 may include an AEC capable of canceling an echo component from an audio signal collected through the microphone, and an NS capable of suppressing background noise from an audio signal received from the AEC. Accordingly, the voice detection module 805 may extract a voice signal from the audio signal, from which the echo component and the background noise are removed by the AEC and the NS. Here, the term “echo” may refer to a phenomenon in which an audio signal, which is output through the speaker, flows into the microphone.

The server 810 may extract a voice command by using the content reproduction information and the voice signal received from the electronic device 800, and may extract content according to the voice command from content providing servers 820-1 to 820-n and may transmit the extracted content to the electronic device 800. For example, the server 810 may include a language recognition module 811, a content determination module 813, a natural language processing module 815, an operation determination module 817, and a content collection module 819.

The language recognition module 811 may convert the voice signal, which has been received from the voice detection module 805 of the electronic device 800, into text data. At this time, the language recognition module 811 may transmit extraction time point information of the voice signal to the content determination module 813.

The content determination module 813 may identify content that the electronic device 800 is reproducing at a time point when the electronic device 800 receives a voice signal by using the content reproduction information received from the electronic device 800 and the extraction time point information of the voice signal received from the language recognition module 811. For example, the content determination module 813 may include a reception time point detection module and a session selection module. The reception time point detection module may detect a time point of reception of a voice signal by the electronic device 800, by using the extraction time point information of the voice signal received from the language recognition module 811. The session selection module may compare the content reproduction information received from the electronic device 800 with the time point of reception of the voice signal by the electronic device 800, which has been identified by the reception time point detection module, and may identify content that the electronic device 800 has been reproducing at the time point of reception of the voice signal by the electronic device 800. Here, the content reproduction information may include content that the electronic device 800 reproduces or is reproducing, and a time point of reproduction of the relevant content.

The natural language processing module 815 may analyze the text data received from the language recognition module 811, and may extract the intent of a user and a keyword which are included in the text data. The natural language processing module 815 may analyze the text data received from the language recognition module 811, and may extract a voice command included in the voice signal. At this time, the natural language processing module 815 may analyze the text data received from the language recognition module 811 by using the information on the content that the electronic device 800 has been reproducing at the time point of reception of the voice signal by the electronic device 800 and that has been identified by the content determination module 813, and thereby may extract a voice command included in the voice signal. For example, when the text data “detailed information on current news” is received from the language recognition module 811, the natural language processing module 815 may analyze the text data received from the language recognition module 811, and may recognize that the voice signal requires detailed information on news currently being reproduced. At this time, the natural language processing module 815 may recognize accurate information on the news currently being reproduced, in view of the content information received from the content determination module 813.

The operation determination module 817 may generate a control command for an operation of the controller 801 according to the voice command extracted by the natural language processing module 815. For example, when the natural language processing module 815 recognizes that detailed information on “news currently being reproduced (e.g., the sudden disclosure of a mobile phone)” is required, the operation determination module 817 may generate a control command for reproducing the detailed information on “sudden disclosure of a mobile phone.”

The content collection module 819 may collect content, which is to be provided from the content providing servers 820-1 to 820-n to the electronic device 800, according to the control command received from the operation determination module 817, and may transmit the collected content to the electronic device 800. For example, when the control command for reproducing the detailed information on “sudden disclosure of a mobile phone” is received from the operation determination module 817, the content collection module 819 may collect one or more pieces of content related to “sudden disclosure of a mobile phone” from the content providing servers 820-1 to 820-n, and may transmit the collected one or more pieces of content to the electronic device 800.

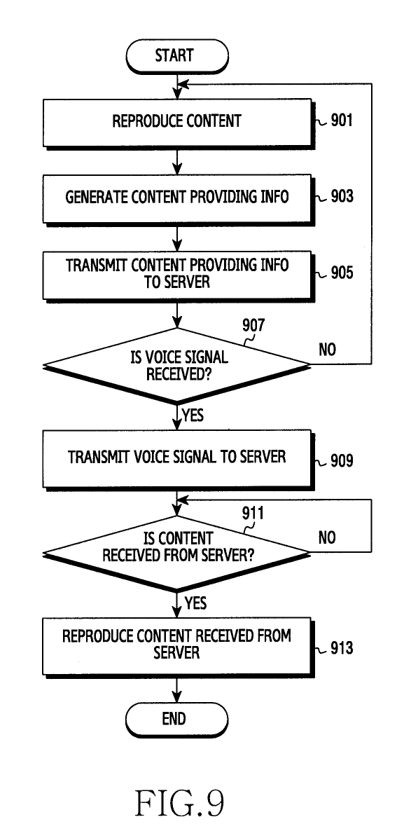

FIG. 9 illustrates a procedure for transmitting content information to a server by an electronic device according to various embodiments of the present disclosure.

Referring to FIG. 9, in operation 901, the electronic device may reproduce content. For example, the electronic device may convert the content, which has been received from the server, into a voice signal or an audio signal by using a TTS module, and may output the voice signal or the audio signal through a speaker. Here, the voice signal or the audio signal may include a sequence of multiple components.

When the content is reproduced, in operation 903, the electronic device may generate content reproduction information including the reproduced content and reproduction time point information of the content.

In operation 905, the electronic device may transmit the content reproduction information to the server. For example, referring to FIG. 8, the controller 801 of the electronic device 800 may transmit content reproduction information to the content determination module 813 of the server 810.

In operation 907, the electronic device may receive a voice signal. For example, the electronic device may extract a voice signal from an audio signal received through a microphone.

When the voice signal is received, in operation 909, the electronic device may transmit the voice signal to the server. At this time, the electronic device may transmit, to the server, the voice signal and information on a time point of extraction of the voice signal.

In operation 911, the electronic device may determine whether content has been received from the server.

When the content has been received from the server, in operation 913, the electronic device may reproduce the content received from the server. At this time, the electronic device may convert the content, which has been received from the server, into a voice signal through the TTS module, and may output the voice signal through the speaker.

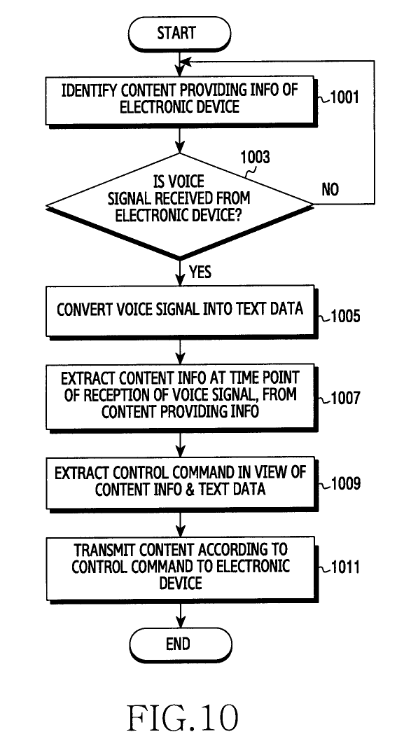

FIG. 10 illustrates a procedure for recognizing a voice command in view of content information of an electronic device by a server according to various embodiments of the present disclosure.

Referring to FIG. 10, in operation 1001, the server may identify content reproduction information of the electronic device. For example, the server may identify content reproduced by that the electronic device and reproduction time information of the relevant content, from the content reproduction information received from the electronic device.

In operation 1003, the server may determine whether a voice signal has been received from the electronic device.

When the voice signal has been received from the electronic device, in operation 1005, the server may convert the voice signal, which has been received from the electronic device, into text data.

In operation 1007, the server may identify information on content that the electronic device has been reproducing at a time point of reception of the voice signal, by using content reproduction information of the electronic device and a time point of extraction of the voice signal by the electronic device. At this time, the server may identify information on the time point of the extraction of the voice signal by the electronic device which is included in the voice signal.

In operation 1009, the electronic device may generate a control command in view of the content information and voice signal. For example, when the voice signal is converted into the text data “detailed information on current news,” the server may analyze the text data through a natural language processing module, and may recognize that the voice signal requires detailed information on news currently being reproduced. At this time, according to the content information received from the electronic device, the natural language processing module may recognize that the voice signal requires detailed information on “sudden disclosure of a mobile phone.” Accordingly, the electronic device may generate a control command for reproducing the detailed information on “sudden disclosure of a mobile phone.”

In operation 1011, the server may extract content according to the control command and may transmit the extracted content to the electronic device. For example, referring to FIG. 8, the server may extract content according to the control command from the content providing servers 820-1 to 820-n, and may transmit the extracted content to the electronic device 800.

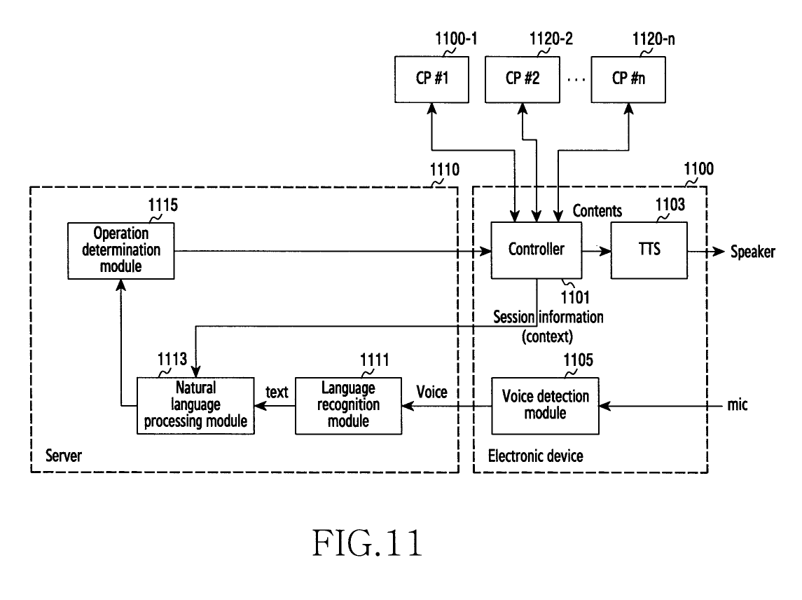

FIG. 11 illustrates a block configuration of a voice recognition system for recognizing a voice command in view of content information of an electronic device according to various embodiments of the present disclosure.

Referring to FIG. 11, the voice recognition system may include the electronic device 1100 and a server 1110.

The electronic device 1100 may receive a voice signal through a microphone, and may extract content according to a control command received from the server 1110 and may reproduce the extracted content. For example, the electronic device 1100 may include a controller 1101, a TTS module 1103, and a voice detection module 1105.

The controller 1101 may control an overall operation of the electronic device 1100. The controller 1101 may perform a control operation for extracting content according to a control command received from the server 1110, from content providing servers 1120-1 to 1120-n, and reproducing the extracted content. For example, the controller 1101 may perform a control operation for converting the content according to the control command, which has been received from the server 1110, into a voice signal or an audio signal through the TTS module 1103, and outputting the voice signal or the audio signal through a speaker.

The controller 1101 may transmit content information on content, which is being output through the speaker at a time point when the voice detection module 1105 extracts the voice signal, to the server 1110. For example, when the voice detection module 1105 extracts a voice signal during reproduction of the major news 2005 with reference to FIG. 20A, the controller 1101 may transmit content information on the major news 2005 to the server 1110. As another example, when the voice detection module 1105 extracts a voice signal during reproduction of “song 1” with reference to FIG. 21A, the controller 1101 may transmit content information on “song 1” to the server 1110. As still another example, the controller 1101 may transmit, to the server 1110, content information on content reproduced at a time point preceding, by a reference time period, a time point of reception of voice signal extraction information. However, when the content does not exist which is being output through the speaker at the time point when the voice detection module 1105 extracts the voice signal, the controller 1101 may not transmit the content information to the server 1110.

The TTS module 1103 may convert the content, which has been received from the controller 1101, into a voice signal or an audio signal, and may output the voice signal or the audio signal through the speaker. Here, the voice signal or the audio signal may include a sequence of multiple components.

The voice detection module 1105 may extract a voice signal from an audio signal collected through the microphone and may provide the extracted voice signal to the server 1110. For example, the voice detection module 1105 may include an AEC capable of canceling an echo component from an audio signal collected through the microphone, and an NS capable of suppressing background noise from an audio signal received from the AEC. Accordingly, the voice detection module 1105 may extract a voice signal from the audio signal, from which the echo component and the background noise are removed by the AEC and the NS. Here, the term “echo” may refer to a phenomenon in which an audio signal, which is output through the speaker, flows into the microphone.

When the electronic device 1100 transmits the content information and the voice signal to the server 1110 as described above, the electronic device 1100 may independently transmit the content information and the voice signal to the server 1110, or may add the content information to the voice signal and may transmit, to the server 1110, the content information added to the voice signal.

The server 1110 may extract a voice command by using the content information and the voice signal received from the electronic device 1100, and may generate a control command according to the voice command and may transmit the generated control command to the electronic device 1100. For example, the server 1110 may include a language recognition module 1111, a natural language processing module 1113, and an operation determination module 1115.

The language recognition module 1111 may convert the voice signal, which has been received from the voice detection module 1105 of the electronic device 1100, into text data.

The natural language processing module 1113 may analyze the text data received from the language recognition module 1111, and may extract the intent of a user and a keyword which are included in the text data. The natural language processing module 1113 may analyze the text data received from the language recognition module 1111, and may extract a voice command included in the voice signal. At this time, the natural language processing module 1113 may analyze the text data received from the language recognition module 1111 by using the content information received from the controller 1101 of the electronic device 1100, and thereby may extract a voice command included in the voice signal. For example, when the text data “detailed information on current news” is received from the language recognition module 1111, the natural language processing module 1113 may analyze the text data received from the language recognition module 1111, and may recognize that the voice signal requires detailed information on news currently being reproduced. At this time, the natural language processing module 1113 may recognize accurate information on the news currently being reproduced, in view of the content information received from the controller 1101.

The operation determination module 1115 may generate a control command for an operation of the controller 1101 according to the voice command extracted by the natural language processing module 1113, and may transmit the generated control command to the electronic device 1100. For example, when the natural language processing module 1113 recognizes that detailed information on “news currently being reproduced (e.g., the sudden disclosure of a mobile phone)” is required, the operation determination module 1115 may generate a control command for reproducing the detailed information on “sudden disclosure of a mobile phone,” and may transmit the generated control command to the electronic device 1100.

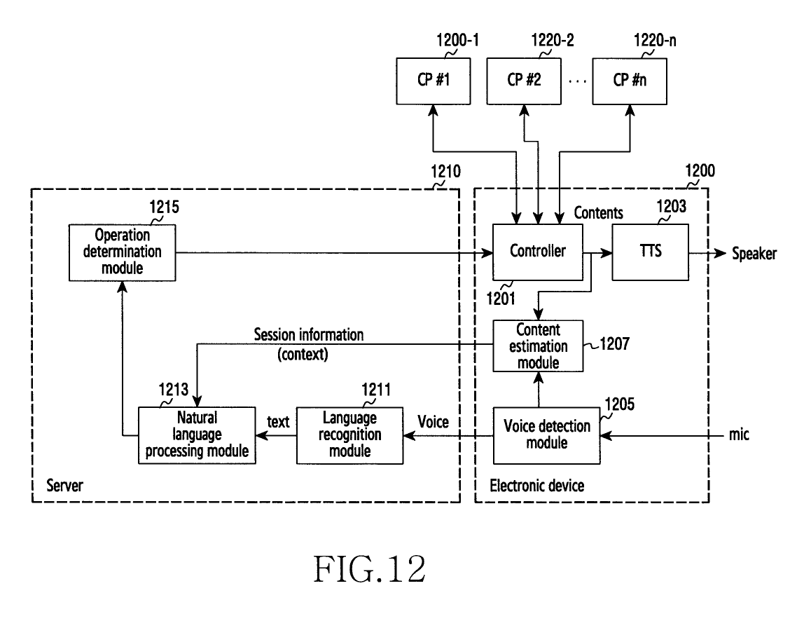

As described above, the controller 1101 of the electronic device 1100 may transmit, to the server 1110, content information on content which is being output through the speaker at a time point when the voice detection module 1105 detects a voice signal. At this time, the electronic device 1100 may identify the content, which is being reproduced at a time point when the voice detection module 1105 detects a voice signal, by using a content estimation module 1207 as illustrated in FIG. 12 below.

FIG. 12 illustrates a block configuration of a voice recognition system for recognizing a voice command in view of content information of an electronic device according to various embodiments of the present disclosure.

Referring to FIG. 12, the voice recognition system may include the electronic device 1200 and a server 1210. In the following description, a configuration and an operation of the server 1210 are identical to those of the server 1110 illustrated in FIG. 11, and thus, a detailed description thereof will be omitted.

The electronic device 1200 may receive a voice signal through a microphone, and may reproduce content according to a control command received from the server 1210. For example, the electronic device 1200 may include a controller 1201, a TTS module 1203, a voice detection module 1205, and a content estimation module 1207.

The controller 1201 may control an overall operation of the electronic device 1200. The controller 1201 may perform a control operation for extracting content according to a control command received from the server 1210, from content providing servers 1220-1 to 1220-n, and reproducing the extracted content. For example, the controller 1201 may perform a control operation for converting the content according to the control command, which has been received from the server 1210, into a voice signal or an audio signal through the TTS module 1203, and outputting the voice signal or the audio signal through a speaker.

The TTS module 1203 may convert the content, which has been received from the controller 1201, into a voice signal or an audio signal, and may output the voice signal or the audio signal through the speaker. Here, the voice signal or the audio signal may include a sequence of multiple components.

The voice detection module 1205 may extract a voice signal from an audio signal collected through the microphone and may provide the extracted voice signal to the server 1210. For example, the voice detection module 1205 may include an AEC capable of canceling an echo component from an audio signal collected through the microphone, and an NS capable of suppressing background noise from an audio signal received from the AEC. Accordingly, the voice detection module 1205 may extract a voice signal from the audio signal, from which the echo component and the background noise are removed by the AEC and the NS. Here, the term “echo” may refer to a phenomenon in which an audio signal, which is output through the speaker, flows into the microphone.

When the voice signal is extracted from the audio signal collected through the microphone, the voice detection module 1205 may generate voice signal extraction information at a time point of extraction of the voice signal and may transmit the generated voice signal extraction information to the content estimation module 1207. Here, the voice signal extraction information may include time point information on the time point when the voice detection module 1205 has extracted the voice signal.

The content estimation module 1207 may monitor content transmitted from the controller 1201 to the TTS module 1203. Accordingly, the content estimation module 1207 may identify information on the content transmitted from the controller 1201 to the TTS module 1203 at a time point of extraction of the received voice signal by the voice detection module 1205, and may transmit the identified information to the server 1210. At this time, the content estimation module 1207 may identify the time point when the voice detection module 1205 has extracted the received voice signal, from the voice signal extraction information received from the voice detection module 1205.

In the above-described embodiment, the content estimation module 1207 may monitor the content transmitted from the controller 1201 to the TTS module 1203, and may identify the information on the content transmitted from the controller 1201 to the TTS module 1203 at the time point of the extraction of the received voice signal by the voice detection module 1205.

In another embodiment, the content estimation module 1207 may monitor content which is output from the TTS module 1203. Accordingly, the content estimation module 1207 may identify information on content, which has been output from the TTS module 1203 at a time point of extraction of a received voice signal by the voice detection module 1205, and may transmit the identified information to the server 1210.

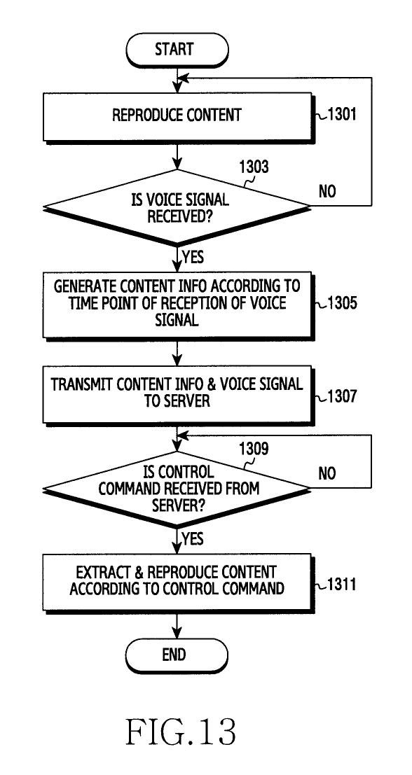

FIG. 13 illustrates a procedure for transmitting content information to a server by an electronic device according to various embodiments of the present disclosure.

Referring to FIG. 13, in operation 1301, the electronic device may reproduce content. For example, the electronic device may convert the content, which has been received from the server, into a voice signal or an audio signal by using a TTS module, and may output the voice signal or the audio signal through a speaker. Here, the voice signal or the audio signal may include a sequence of multiple components.

While the content is reproduced, in operation 1303, the electronic device may receive a voice signal. For example, the electronic device may extract a voice signal from an audio signal received through a microphone.

When the voice signal is received, in operation 1305, the electronic device may generate content information on the content being reproduced at a time point of reception of the voice signal. For example, referring to FIG. 12, by using the content estimation module 1207, the electronic device may identify the content transmitted from the controller 1201 to the TTS module 1203 at a time point of extraction of the received voice signal by the voice detection module 1205, and may generate content information. At this time, the electronic device may identify content transmitted from the controller 1201 to the TTS module 1203 at a time point preceding, by a reference time period, the time point when the voice detection module 1205 extracts the voice signal, and may generate content information. However, when the content does not exist which is transmitted from the controller 1201 to the TTS module 1203 at the time point of reception of the voice signal, the electronic device may not generate the content information. As another example, referring to FIG. 12, by using the content estimation module 1207, the electronic device may identify the content, which has been output from the TTS module 1203 at a time point of extraction of the received voice signal by the voice detection module 1205, and may generate content information. At this time, the electronic device may identify content which has been output from the TTS module 1203 at a time point preceding, by a reference time period, the time point when the voice detection module 1205 extracts the received voice signal, and may generate content information. However, when the content does not exist which is output from the TTS module 1203 at the time point of reception of the voice signal, the electronic device may not generate the content information.

In operation 1307, the electronic device may transmit the content information and the voice signal to the server. At this time, the electronic device may independently transmit the content information and the voice signal to the server, or may add the content information to the voice signal and may transmit, to the server, the content information added to the voice signal.

In operation 1309, the electronic device may determine whether a control command has been received from the server.

When the control command has been received from the server, in operation 1311, the electronic device may extract content according to the control command received from the server and may reproduce the extracted content. For example, the electronic device may extract content according to the control command received from the server, from a data storage module or content providing servers. Thereafter, the electronic device may convert the content according to the control command through the TTS module, into a voice signal, and may output the voice signal through the speaker.

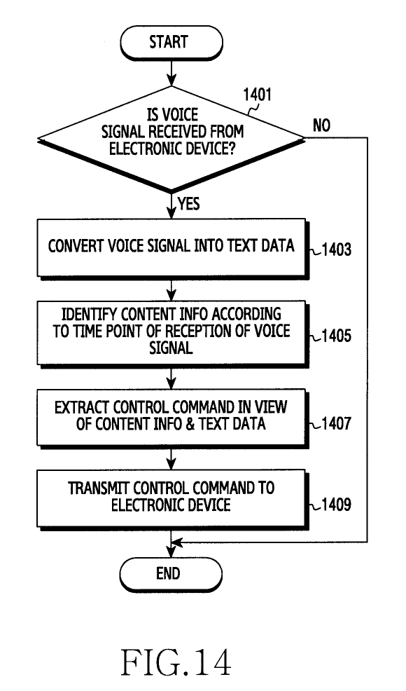

FIG. 14 illustrates a procedure for recognizing a voice command in view of content information of an electronic device by a server according to various embodiments of the present disclosure.

Referring to FIG. 14, in operation 1401, the server may determine whether a voice signal has been received from the electronic device.

When the voice signal has been received from the electronic device, in operation 1403, the server may convert the voice signal, which has been received from the electronic device, into text data.

In operation 1405, the server may identify information on content that the electronic device has been reproducing at a time point of reception of the voice signal. For example, the server may receive content information from the electronic device. As another example, in operation 1401, the server may identify content information included in the voice signal received from the electronic device.

In operation 1407, the electronic device may generate a control command in view of the content information and voice signal. For example, when the voice signal is converted into the text data “detailed information on current news,” the server may analyze the text data through a natural language processing module, and may recognize that the voice signal requires detailed information on news currently being reproduced. At this time, according to the content information received from the electronic device, the natural language processing module may recognize that the voice signal requires detailed information on “sudden disclosure of a mobile phone.” Accordingly, the electronic device may generate a control command for reproducing the detailed information on “sudden disclosure of a mobile phone.”

In operation 1409, the server may transmit the control command to the electronic device.

In the above-described embodiment, the electronic device may transmit, to the server, the content information on the content which is being output through the speaker at the time point of reception of the voice signal.

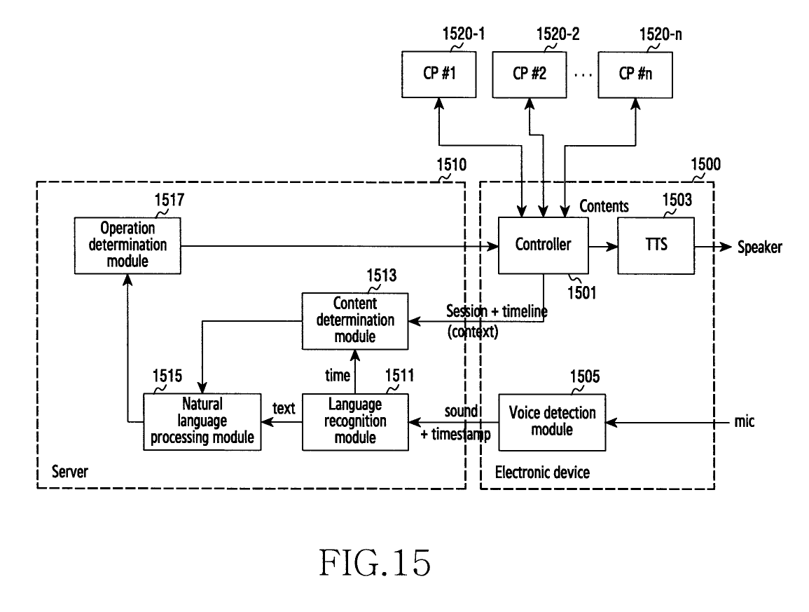

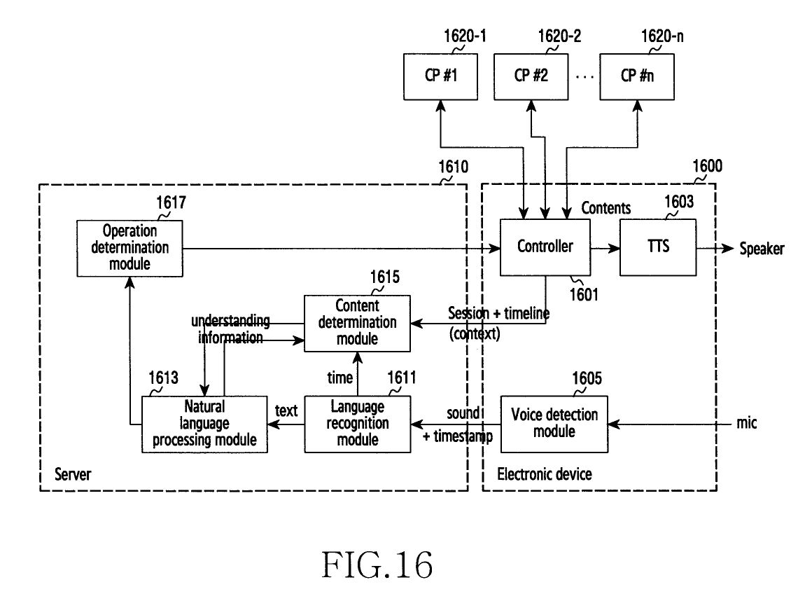

In another embodiment, the electronic device may transmit, to the server, content reproduced by the electronic device and reproduction time point information of the content, with reference to FIG. 15 or 16 below.

FIG. 15 illustrates a block configuration of a voice recognition system for recognizing a voice command in view of content information of an electronic device according to various embodiments of the present disclosure.

Referring to FIG. 15, the voice recognition system may include the electronic device 1500 and a server 1510.

The electronic device 1500 may receive a voice signal through a microphone, and may extract content according to a control command received from the server 1510 and may reproduce the extracted content. For example, the electronic device 1500 may include a controller 1501, a TTS module 1503, and a voice detection module 1505.

The controller 1501 may control an overall operation of the electronic device 1500. The controller 1501 may perform a control operation for extracting content according to a control command received from the server 1510, from content providing servers 1520-1 to 1520-n, and reproducing the extracted content. For example, the controller 1501 may perform a control operation for converting the content according to the control command, which has been received from the server 1510, into a voice signal or an audio signal through the TTS module 1503, and outputting the voice signal or the audio signal through a speaker.

The controller 1501 may transmit content reproduction information, which is controlled to be output through the speaker, to the server 1510. Here, the content reproduction information may include content, that the electronic device 1500 reproduces according to the control of the controller 1501, and reproduction time point information of the relevant content. For example, when a daily briefing service is provided, with reference to FIG. 20A, the controller 1501 may perform a control operation for sequentially extracting weather information 2001, stock information 2003, and major news 2005, and outputting the extracted sequence of the multiple components through the speaker, according to setting information of the daily briefing service. In this case, the controller 1501 may transmit, to the server 1510, information on the weather information 2001, the stock information 2003, and the major news 2005, which are output through the speaker, and reproduction time point information of each of the weather information 2001, the stock information 2003, and the major news 2005. As another example, when a music reproduction service is provided, with reference to FIG. 21A, the controller 1501 may perform a control operation for reproducing music files included in a reproduction list and outputting the one or more reproduced music files through the speaker. In this case, the controller 1501 may transmit, to the server 1510, music file information on the reproduced music files and reproduction time point information of each of the music files. At this time, whenever content is reproduced, the controller 1501 may transmit, to the server 1510, content information on the relevant content and reproduction time point information of the relevant content.

The TTS module 1503 may convert the content, which has been received from the controller 1501, into a voice signal or an audio signal, and may output the voice signal or the audio signal through the speaker. Here, the voice signal or the audio signal may include a sequence of multiple components.

The voice detection module 1505 may extract a voice signal from an audio signal collected through the microphone and may provide the extracted voice signal to the server 1510. At this time, the voice detection module 1505 may transmit information on a time point of extraction of the voice signal and the voice signal together to the server 1510. For example, the voice detection module 1505 may include an AEC capable of canceling an echo component from an audio signal collected through the microphone, and an NS capable of suppressing background noise from an audio signal received from the AEC. Accordingly, the voice detection module 1505 may extract a voice signal from the audio signal, from which the echo component and the background noise are removed by the AEC and the NS. Here, the term “echo” may refer to a phenomenon in which an audio signal, which is output through the speaker, flows into the microphone.

The server 1510 may extract a voice command by using the content reproduction information and the voice signal received from the electronic device 1500, and may generate a control command according to the voice command and may transmit the generated control command to the electronic device 1500. For example, the server 1510 may include a language recognition module 1511, a content determination module 1513, a natural language processing module 1515, and an operation determination module 1517.

The language recognition module 1511 may convert the voice signal, which has been received from the voice detection module 1505 of the electronic device 1500, into text data. At this time, the language recognition module 1511 may transmit extraction time point information of the voice signal to the content determination module 1513.

The content determination module 1513 may identify content that the electronic device 1500 is reproducing at a time point when the electronic device 1500 receives a voice signal by using the content reproduction information received from the electronic device 1500 and the extraction time point information of the voice signal received from the language recognition module 1511. For example, the content determination module 1513 may include a reception time point detection module and a session selection module. The reception time point detection module may detect a time point of reception of a voice signal by the electronic device 1500, by using the extraction time point information of the voice signal received from the language recognition module 1511. The session selection module may compare the content reproduction information received from the electronic device 1500 with the time point of reception of the voice signal by the electronic device 1500, which has been identified by the reception time point detection module, and may identify content that the electronic device 1500 has been reproducing at the time point of reception of the voice signal by the electronic device 1500. Here, the content reproduction information may include content that the electronic device 1500 reproduces or is reproducing, and a time point of reproduction of the relevant content.

The natural language processing module 1515 may analyze the text data received from the language recognition module 1511, and may extract the intent of a user and a keyword which are included in the text data. The natural language processing module 1515 may analyze the text data received from the language recognition module 1511, and may extract a voice command included in the voice signal. At this time, the natural language processing module 1515 may analyze the text data received from the language recognition module 1511 by using the information on the content that the electronic device 1500 has been reproducing at the time point of reception of the voice signal by the electronic device 1500 and that has been identified by the content determination module 1513, and thereby may extract a voice command included in the voice signal. For example, when the text data “detailed information on current news” is received from the language recognition module 1511, the natural language processing module 1515 may analyze the text data received from the language recognition module 1511, and may recognize that the voice signal requires detailed information on news currently being reproduced. At this time, the natural language processing module 1515 may recognize accurate information on the news currently being reproduced, in view of the content information received from the content determination module 813.

The operation determination module 1517 may generate a control command for an operation of the controller 1501 according to the voice command extracted by the natural language processing module 1515, and may transmit the generated control command to the electronic device 1500. For example, when the natural language processing module 1515 recognizes that detailed information on “news currently being reproduced (e.g., the sudden disclosure of a mobile phone)” is required, the operation determination module 1517 may generate a control command for reproducing the detailed information on “sudden disclosure of a mobile phone,” and may transmit the generated control command to the electronic device 1500.

FIG. 16 illustrates a block configuration of a voice recognition system for recognizing a voice command in view of content information of an electronic device according to various embodiments of the present disclosure.

Referring to FIG. 16, the voice recognition system may include the electronic device 1600 and a server 1610. In the following description, a configuration and an operation of the electronic device 1600 are identical to those of the electronic device 1500 illustrated in FIG. 15, and thus, a detailed description thereof will be omitted.

The server 1610 may extract a voice command by using the content reproduction information and the voice signal received from the electronic device 1600, and may generate a control command according to the voice command and may transmit the generated control command to the electronic device 1600. For example, the server 1610 may include a language recognition module 1611, a content determination module 1613, a natural language processing module 1615, and an operation determination module 1617.

The language recognition module 1611 may convert the voice signal, which has been received from the voice detection module 1605 of the electronic device 1600, into text data. At this time, the language recognition module 1611 may transmit extraction time point information of the voice signal to the content determination module 1613.

The natural language processing module 1615 may analyze the text data received from the language recognition module 1611, and may extract the intent of a user and a keyword which are included in the text data. The natural language processing module 1615 may analyze the text data received from the language recognition module 1611, and may extract a voice command included in the voice signal. At this time, in order to extract the intent of a user and a keyword which are clear and are included in the voice signal, the natural language processing module 1615 may analyze text data received from the language recognition module 1611 and may transmit an extracted voice command to the content determination module 1613. For example, when text data reading “Well, let me know detailed information on news reported just moments ago” is received from the language recognition module 1611, the natural language processing module 1615 may recognize that “let” excluding “Well,” is a start time point of a voice command included in the voice signal. Accordingly, the natural language processing module 1615 may transmit the voice command “detailed information on news reported just moments ago” to the content determination module 1613. The natural language processing module 1615 may analyze the text data received from the language recognition module 1611 by using the information on the content that the electronic device 1600 has been reproducing at the time point of reception of the voice signal by the electronic device 1600 and that has been identified by the content determination module 1613, and thereby may extract a voice command included in the voice signal. For example, when the voice signal “Well, let me know detailed information on news reported just moments ago” is received from the electronic device 1600, the natural language processing module 1615 may clearly recognize news information that the electronic device 1600 is reproducing not at a time point of reception of “Well,” but at a time point of reception of “let.”

The content determination module 1613 may identify content that the electronic device 1600 is reproducing at a time point when the electronic device 1600 receives a voice signal by using the content reproduction information received from the electronic device 1600, the extraction time point information of the voice signal received from the language recognition module 1611, and the voice command received from the natural language processing module 1615. For example, the content determination module 1613 may include a voice command detection module, a reception time point detection module, and a session selection module.

The voice command detection module may detect a keyword for generating a control command by using voice command information received from the natural language processing module 1615. For example, when voice command information of “detailed information on news reported just moments ago” is received from the natural language processing module 1615, the voice command detection module may detect “news reported just moments ago” as a keyword for generating a control command.

The reception time point detection module may detect a time point of reception of a voice signal by the electronic device 1600, by using the extraction time point information of the voice signal received from the language recognition module 1611 and the keyword received from the voice command detection module. For example, when the voice signal “Well, let me know detailed information on news reported just moments ago” is received from the electronic device 1600, the reception time point detection module may receive time point information of reception of “Well,” by the electronic device 1600, from the language recognition module 1611. However, the reception time point detection module may determine that it is required to identify content that the electronic device 1600 is reproducing not at a time point of reception of “Well,” but at a time point of reception of “news reported just moments ago” according to the keyword received from the voice command detection module.

The session selection module may compare the content reproduction information received from the electronic device 1600 with the time point of reception of the voice signal by the electronic device 1600, which has been identified by the reception time point detection module, and may identify content that the electronic device 1600 has been reproducing at the time point of reception of the voice signal by the electronic device 1600. Here, the content reproduction information may include content that the electronic device 1600 reproduces or is reproducing, and a time point of reproduction of the relevant content.

The operation determination module 1617 may generate a control command for an operation of the controller 1601 according to the voice command extracted by the natural language processing module 1615, and may transmit the generated control command to the electronic device 1600. For example, when the natural language processing module 1615 recognizes that detailed information on “news reported just moments ago (e.g., the sudden disclosure of a mobile phone)” is required, the operation determination module 1617 may generate a control command for reproducing the detailed information on “sudden disclosure of a mobile phone,” and may transmit the generated control command to the electronic device 1600.

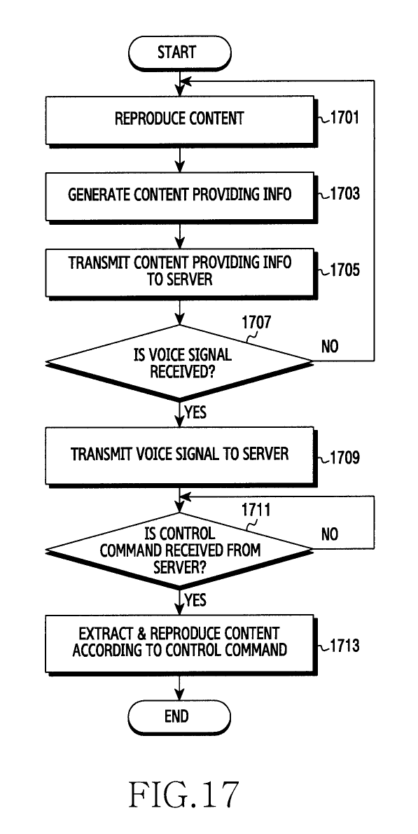

FIG. 17 illustrates a procedure for transmitting content information to a server by an electronic device according to various embodiments of the present disclosure.

Referring to FIG. 17, in operation 1701, the electronic device may reproduce content. For example, the electronic device may convert the content, which has been received from the server, into a voice signal or an audio signal by using a TTS module, and may output the voice signal or the audio signal through a speaker. Here, the voice signal or the audio signal may include a sequence of multiple components.

When the content is reproduced, in operation 1703, the electronic device may generate content reproduction information including the reproduced content and reproduction time point information of the content.

In operation 1705, the electronic device may transmit the content reproduction information to the server. For example, the controller 1501 of the electronic device 1500 illustrated in FIG. 15 may transmit content reproduction information to the content determination module 1513 of the server 1510.

In operation 1707, the electronic device may receive a voice signal. For example, the electronic device may extract a voice signal from an audio signal received through a microphone.

When the voice signal is received, in operation 1709, the electronic device may transmit the voice signal to the server. At this time, the electronic device may transmit, to the server, the voice signal and time point information of extraction of the voice signal.

In operation 1711, the electronic device may determine whether a control command has been received from the server from the server.

When the control command has been received from the server, in operation 1713, the electronic device may extract content according to the control command received from the server and may reproduce the extracted content. For example, the electronic device may extract content according to the control command received from the server, from a data storage module or content providing servers. Thereafter, the electronic device may convert the content according to the control command through the TTS module, into a voice signal, and may output the voice signal through the speaker.

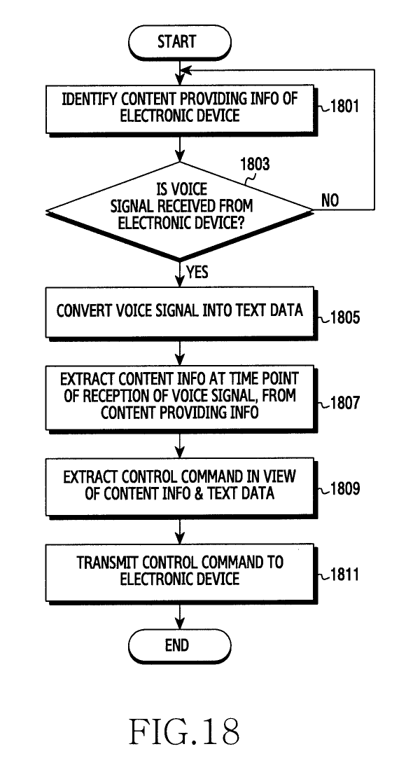

FIG. 18 illustrates a procedure for recognizing a voice command in view of content information of an electronic device by a server according to various embodiments of the present disclosure.

Referring to FIG. 18, in operation 1801, the server may identify content reproduction information of the electronic device. For example, the server may identify content reproduced by the electronic device and reproduction time information of the relevant content, from the content reproduction information received from the electronic device.

In operation 1803, the server may determine whether a voice signal has been received from the electronic device.

When the voice signal has been received from the electronic device, in operation 1805, the server may convert the voice signal, which has been received from the electronic device, into text data.

In operation 1807, the server may identify information on content which has been reproducing at a time point of reception of the voice signal by the electronic device, by using content reproduction information of the electronic device and a time point of extraction of the voice signal by the electronic device. At this time, the server may identify time point information of the extraction of the voice signal by the electronic device which is included in the voice signal.

In operation 1809, the electronic device may generate a control command in view of the content information and voice signal. For example, when the voice signal is converted into the text data “detailed information on current news,” the server may analyze the text data through a natural language processing module, and may recognize that the voice signal requires detailed information on news currently being reproduced. At this time, according to the content information received from the electronic device, the natural language processing module may recognize that the voice signal requires detailed information on “sudden disclosure of a mobile phone.” Accordingly, the electronic device may generate a control command for reproducing the detailed information on “sudden disclosure of a mobile phone.”

In operation 1811, the server may transmit the control command to the electronic device.

In the above-described embodiment, the server may identify the information on the content which has been reproducing at the time point of the reception of the voice signal by the electronic device, by using the content reproduction information of the electronic device and the time point of the extraction of the voice signal by the electronic device.

In another embodiment, the server may identify information on content which has been reproducing at a time point of reception of a voice signal by the electronic device, by using content reproduction information of the electronic device, a time point of extraction of the voice signal by the electronic device, and a voice command related to the voice signal.

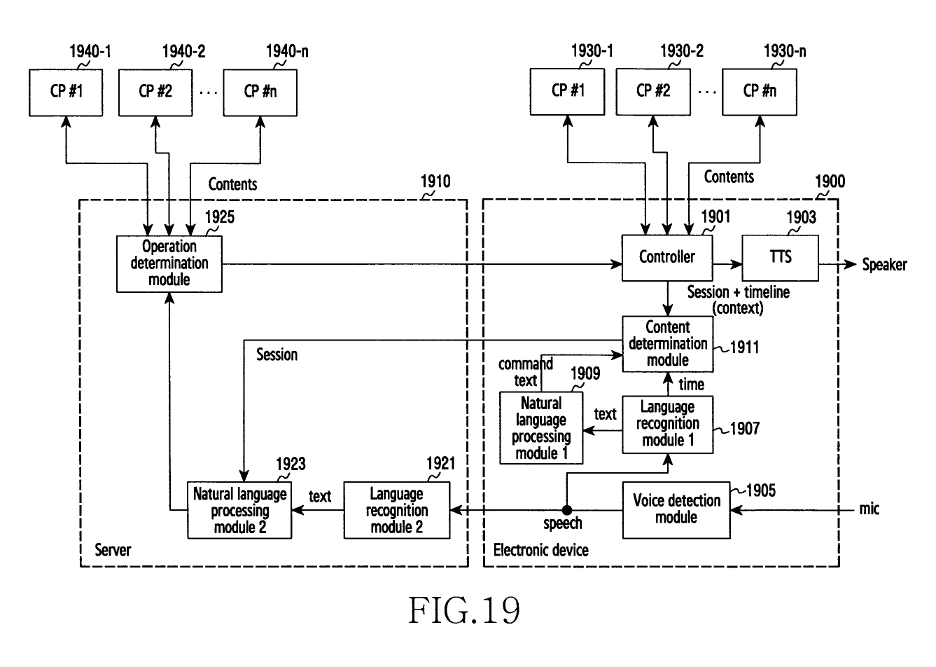

FIG. 19 illustrates a block configuration of a voice recognition system for recognizing a voice command in view of content information of an electronic device according to various embodiments of the present disclosure.

Referring to FIG. 19, the voice recognition system may include the electronic device 1900 and a server 1910.

The electronic device 1900 may receive a voice signal through a microphone, and may extract content according to a control command received from the server 1910 and may reproduce the extracted content. For example, the electronic device 1900 may include a controller 1901, a TTS module 1903, a voice detection module 1905, a first language recognition module 1907, a first natural language processing module 1909, and a content determination module 1911.

The controller 1901 may control an overall operation of the electronic device 1900. The controller 1901 may perform a control operation for extracting content according to a control command received from the server 1920, from content providing servers 1930-1 to 1930-n, and reproducing the extracted content. For example, the controller 1901 may perform a control operation for converting the content according to the control command, which has been received from the server 1920, into a voice signal or an audio signal through the TTS module 1903, and outputting the voice signal or the audio signal through a speaker. Here, the voice signal or the audio signal may include a sequence of multiple components.

The controller 1901 may transmit content reproduction information, which is controlled to be output through the speaker, to the content determination module 1911. Here, the content reproduction information may include content, that the electronic device 1900 reproduces according to the control of the controller 1901, and reproduction time point information of the relevant content. For example, when a daily briefing service is provided with reference to FIG. 20A, the controller 1901 may perform a control operation for sequentially extracting weather information 2001, stock information 2003, and major news 2005, and outputting the extracted sequence of the multiple components through the speaker, according to setting information of the daily briefing service. In this case, the controller 1901 may transmit, to the content determination module 1911, information on the weather information 2001, the stock information 2003, and the major news 2005, which are output through the speaker, and reproduction time point information of each of the weather information 2001, the stock information 2003, and the major news 2005. As another example, when a music reproduction service is provided with reference to FIG. 21A, the controller 1901 may perform a control operation for reproducing music files included in a reproduction list and outputting the one or more reproduced music files through the speaker. In this case, the controller 1901 may transmit, to the content determination module 1911, music file information on the reproduced music files and reproduction time point information of each of the music files. At this time, whenever content is reproduced, the controller 1901 may transmit, to the content determination module 1911, content information on the relevant content and reproduction time point information of the relevant content.

The TTS module 1903 may convert the content, which has been received from the controller 1901, into a voice signal or an audio signal, and may output the voice signal or the audio signal through the speaker.

The voice detection module 1905 may extract a voice signal from an audio signal collected through the microphone and may provide the extracted voice signal to the server 1920 and the first language recognition module 1907. At this time, the voice detection module 1905 may provide information on a time point of extraction of the voice signal and the voice signal together to the first language recognition module 1907. For example, the voice detection module 1905 may include an AEC capable of canceling an echo component from an audio signal collected through the microphone, and an NS capable of suppressing background noise from an audio signal received from the AEC. Accordingly, the voice detection module 1905 may extract a voice signal from the audio signal, from which the echo component and the background noise are removed by the AEC and the NS. Here, the term “echo” may refer to a phenomenon in which an audio signal, which is output through the speaker, flows into the microphone.

The first language recognition module 1907 may convert the voice signal, which has been received from the voice detection module 1905 of the electronic device 1900, into text data. At this time, the language recognition module 1907 may transmit extraction time point information of the voice signal to the content determination module 1911.

The first natural language processing module 1909 may analyze the text data received from the first language recognition module 1907, and may extract the intent of a user and a keyword which are included in the text data. The first natural language processing module 1909 may analyze the text data received from the first language recognition module 1907, and may extract a voice command included in the voice signal. For example, when text data reading “Well, let me know detailed information on news reported just moments ago” is received from the first language recognition module 1907, the first natural language processing module 1909 may recognize that “let” excluding “Well,” is a start time point of a voice command included in the voice signal. Accordingly, the first natural language processing module 1909 may transmit the voice command “detailed information on news reported just moments ago” to the content determination module 1911.

The content determination module 1911 may identify content reproduction information of the electronic device 1900 by using the content reproduction information received from the controller 1901. Here, the content reproduction information may include content that the electronic device 1900 reproduces or is reproducing, and a time point of reproduction of the relevant content. Accordingly, the content determination module 1911 may identify content that the electronic device 1900 is reproducing at a time point of reception of a voice signal by the electronic device 1900, by using the content reproduction information of the electronic device 1900, time point information of extraction of the voice signal received from the first language recognition module 1907, and voice command information received from the first natural language processing module 1909. For example, when the electronic device 1900 receives the voice signal “Well, let me know detailed information on news reported just moments ago,” the content determination module 1911 may receive time point information of extraction of “Well,” by the electronic device 1900, from the first language recognition module 1907. Thereafter, when the voice command “detailed information on news reported just moments ago” is received from the first natural language processing module 1909, the content determination module 1911 may identify content not at a time point of extraction of “Well,” by the electronic device 1900 but at a time point of extraction of “let” by the electronic device 1900, and may provide the identified content to the server 1920.

The content determination module 1911 may identify content that the electronic device 1900 is reproducing at a time point when the electronic device 1900 receives a voice signal by using the content reproduction information received from the controller 1901, the extraction time point information of the voice signal received from the first language recognition module 1907, and the voice command received from the first natural language processing module 1909. For example, the content determination module 1911 may include a voice command detection module, a reception time point detection module, and a session selection module.

The voice command detection module may detect a keyword for generating a control command by using voice command information received from the first natural language processing module 1909. For example, when voice command information of “detailed information on news reported just moments ago” is received from the first natural language processing module 1909, the voice command detection module may detect “news reported just moments ago” as a keyword for generating a control command.

The reception time point detection module may detect a time point of reception of a voice signal by the electronic device 1900, by using the extraction time point information of the voice signal received from the first language recognition module 1907 and the keyword received from the voice command detection module. For example, when the electronic device 1900 receives the voice signal “Well, let me know detailed information on news reported just moments ago,” the reception time point detection module may receive time point information of reception of “Well,” by the electronic device 1900, from the first language recognition module 1907. However, the reception time point detection module may determine that it is required to identify content that the electronic device 1900 is reproducing not at a time point of reception of “Well,” but at a time point of reception of “news reported just moments ago” according to the keyword received from the voice command detection module.

The session selection module may compare the content reproduction information received from the controller 1901 with the time point of reception of the voice signal by the electronic device 1900, which has been identified by the reception time point detection module, and may identify content that the electronic device 1900 has been reproducing at the time point of reception of the voice signal by the electronic device 1900. Here, the content reproduction information may include content that the electronic device 1900 reproduces or is reproducing, and a time point of reproduction of the relevant content.

The server 1920 may extract a voice command by using the content information and the voice signal received from the electronic device 1900, and may generate a control command according to the voice command and may transmit the generated control command to the electronic device 1900. For example, the server 1920 may include a second language recognition module 1921, a second natural language processing module 1923, and an operation determination module 1925.

The second language recognition module 1921 may convert the voice signal, which has been received from the voice detection module 1905 of the electronic device 1900, into text data.

The second natural language processing module 1923 may analyze the text data received from the second language recognition module 1921, and may extract the intent of a user and a keyword which are included in the text data. The second natural language processing module 1923 may analyze the text data received from the second language recognition module 1921, and may extract a voice command included in the voice signal. At this time, the second natural language processing module 1923 may analyze the text data received from the second language recognition module 1921 by using the content information received from the controller 1901 of the electronic device 1900, and thereby may extract a voice command included in the voice signal. For example, when the text data “detailed information on current news” is received from the second language recognition module 1921, the second natural language processing module 1923 may analyze the text data received from the second language recognition module 1921, and may recognize that the voice signal requires detailed information on news currently being reproduced. At this time, the second natural language processing module 1923 may recognize accurate information on the news currently being reproduced, in view of the content information received from the controller 1901.

The operation determination module 1925 may generate a control command for an operation of the controller 1901 according to the voice command extracted by the second natural language processing module 1923. For example, when the second natural language processing module 1923 recognizes that detailed information on “news currently being reproduced (e.g., the sudden disclosure of a mobile phone)” is required, the operation determination module 1925 may generate a control command for reproducing the detailed information on “sudden disclosure of a mobile phone,” and may transmit the generated control command to the electronic device 1900.

In the above-described embodiment, the electronic device may generate content information on content being reproduced at a time point of reception of a voice signal.

In another embodiment, the electronic device may generate content information on content being reproduced at one or more time points among a time point of utterance by a user, an input time point of a command included in a voice signal, and a time point of reception of an audio signal including a voice signal. Methods according to embodiments stated in the claims and/or specifications may be implemented by hardware, software, or a combination of hardware and software.

In the implementation of software, a computer-readable storage medium for storing one or more programs (software modules) may be provided. The one or more programs stored in the computer-readable storage medium may be configured for execution by one or more processors within the electronic device. The one or more programs may include instructions for allowing the electronic device to perform methods according to embodiments stated in the claims and/or specifications of the present invention.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Alternatively, the programs may be stored in a memory configured by a combination of some or all of the listed components. Further, a plurality of configuration memories may be included.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. The storage device may access the electronic device through an external port.

Further, a separate storage device on a communication network may access a portable electronic device.

As described above, a voice command may be recognized in view of content information on content that the electronic device is reproducing at a time point of reception of a voice signal by the electronic device, so that a voice command related to the voice signal can be clearly recognized. The term module as used herein may, for example, mean a unit including one of hardware, software, and firmware or a combination of two or more of them. The module may be interchangeably used with, for example, the term unit, logic, logical block, component, or circuit. The module may be a minimum unit of an integrated component element or a part thereof.

Although specific exemplary embodiments have been described in the detailed description of the present invention, various change and modifications may be made without departing from the spirit and scope of the present invention. Therefore, the scope of the present invention should not be defined as being limited to the embodiments, but should be defined by the appended claims and equivalents thereof.

1. An operating method of an electronic device, the operating method comprising:
outputting a voice signal or an audio signal including multiple continuous components;
receiving a voice signal;
determining one or more components among the multiple components by using a time point of receiving the voice signal; and
transmitting, to a server, the one or more components or at least part of information on the one or more components and the voice signal.

2. The operating method of claim 1, wherein the outputting of the voice signal or the audio signal comprises:
converting content into the voice signal or the audio signal by using a Text-To-Speech (TTS) module; and
outputting the voice signal or the audio signal through a speaker.

3. The operating method of claim 2, wherein the determining of the one or more components comprises determining the one or more components which are input to the TTS module or are output from the TTS module among components included in the voice signal or the audio signal, by using the time point of receiving the voice signal.

4. The operating method of claim 1, further comprising:
receiving response information to the voice signal from the server; and
outputting the response information.

5. The operating method of claim 1, further comprising:
receiving response information to the voice signal from the server;
extracting content corresponding to the response information from a memory and at least one content server; and
outputting the content.

6. (canceled)

7. (canceled)

8. An electronic device comprising:
an output module that outputs a voice signal or an audio signal including multiple continuous components;
a reception module that receives a voice signal; and
a controller that determines one or more components among the multiple components by using a time point of receiving the voice signal,
wherein the electronic device transmits, to a server, the one or more components or at least part of information on the one or more components and the voice signal.

9. The electronic device of claim 8, wherein the output module comprises:
a Text-To-Speech (TTS) module that converts content into the voice signal or the audio signal; and
a speaker that outputs the voice signal or the audio signal to an outside.

10. The electronic device of claim 9, wherein the controller determines the one or more components which are input to the TTS module or are output from the TTS module among components included in the voice signal or the audio signal, by using the time point of receiving the voice signal by the reception module.

11. The electronic device of claim 8, wherein the controller performs a control operation for receiving response information to the voice signal from the server, and outputting the response information through the output module.

12. The electronic device of claim 8, wherein the controller performs a control operation for extracting content according to response information to the voice signal received from the server, from a memory and at least one content server, and outputting the extracted content through the output module.

13. An apparatus in a server, the apparatus comprising:
a language recognition module that receives a voice signal from an electronic device;
a natural language processing module that identifies one or more components according to the voice signal among multiple components included in a voice signal or an audio signal which is output from the electronic device; and
an operation determination module that generates response information to the voice signal based on the one or more components or at least part of information on the one or more components, and transmits, to the electronic device, the response information to the voice signal.

14. The apparatus of claim 13, wherein the natural language processing module generates natural language information by using the one or more components or at least part of information on the one or more components and the voice signal.

15. The apparatus of claim 13, wherein the operation determination module generates content or a control signal for selecting content which corresponds to the voice signal, based on the natural language information generated by the natural language processing module.

16. The operating method of claim 1, wherein the time point of the reception of the voice signal include one or more of a time point of utterance by a user, an input time point of a command included in the voice signal, a time point of reception of an audio signal including the voice signal, and a time point of the reception of the voice signal.

17. The operating method of claim 1, wherein the receiving of the voice signal comprising receiving an audio signal through a microphone; and
extracting the voice signal included in the audio signal.

18. The operating method of claim 1, wherein the information on the components include one or more pieces of information among session information of the components and music file information.

19. The electronic device of claim 8, wherein the time point of the reception of the voice signal include one or more of a time point of utterance by a user, an input time point of a command included in the voice signal, a time point of reception of an audio signal including the voice signal, and a time point of the reception of the voice signal.

20. The electronic device of claim 8, further comprising:
a microphone;
wherein the reception module extract a voice signal from an audio signal received through the microphone.

21. The electronic device of claim 8, wherein the information on the components include one or more pieces of information among session information of the components and music file information.
